(19) United States
(12) Patent Application Publication
(10) Pub. No.: US 2009/0011222 A1
(43) Pub. Date: Jan. 8, 2009

(54) SUPERHYDROPHOBIC SURFACE AND METHOD FOR FORMING SAME

(75) Inventors: Yonghao Xiu, Atlanta, GA (US); Lingbo Zhu, Atlanta, GA (US); Dennis W. Hess, Atlanta, GA (US); Ching Ping Wong, Berkeley Lake, GA (US); Fei Xiao, Atlanta, GA (US); Robert N. Hampton, Peachtree City, GA (US); Franklin C. Lambert, Palmetto, GA (US)

Correspondence Address: TROUTMAN SANDERS LLP, 600 PEACHTREE STREET , NE, ATLANTA, GA, 30308, US

(73) Assignee: Georgia Tech Research Corporation, Atlanta, GA (US)

(21) Appl. No.: 11/610,111

(22) Filed: Dec. 13, 2006

Related U.S. Application Data
(60) Provisional application No. 60/793,801, filed on Apr. 23, 2006.
(60) Provisional application No. 60/786,305, filed on Mar. 27, 2006.

(51) Int. Cl. B05D 3/12; B05D 3/00; B05D 3/02; B05D 1/02; B05D 1/18; B32B 1/00; B32B 33/00

(52) U.S. Cl. 428/323; 427/299; 427/430.1; 427/240; 427/421.1; 427/372.2; 428/411.1

(57) ABSTRACT

The present invention is a method of applying Lotus Effect materials as a (superhydrophobicity) protective coating for various system applications, as well as the method of fabricating/preparing Lotus Effect coatings.

### CROSS-REFERENCE TO RELATED APPLICATIONS

Under the provisions of 35 U.S.C. § 119(e), this application claims the benefit of U.S. Provisional Application Nos. 60/786,305 filed 27 Mar. 2006, and 60/793,801 filed 23 Apr. 2006, both of which are incorporated herein by reference.

### BACKGROUND OF THE INVENTION

1. Field of the Invention

This invention relates generally to the field of superhydrophobic surface coatings, and methods for forming same.

2. Description of Related Art

The Lotus Effect is named after the lotus plant, and was first used for technical applications by Professor Wilhelm Barthlott from the University of Bonn. The Lotus Effect generally refers to two characteristic properties: superhydrophobicity and self-cleaning, although in some instances, either one of these properties provide the benefits of the Lotus Effect.

Superhydrophobicity is manifested by a water contact angle larger than 150°, while self-cleaning indicates that loose (non-adhered) dirt particles such as dust or soot are picked up by a drop of water as it rolls off the surface, and are thus removed. The superhydrophobicity and self-cleaning properties of a Lotus Effect surface are illustrated in FIG. 1.

TABLE 1 provides common definitions of liquid/surface phenomena related to ionized water. For example, it will be understood that the values will change with other liquids, such as saline solution, wherein in a low concentration saline solution, there is no appreciable effect, but in higher saline concentrations, the contact angle will be greater. Thus, these definitions are also applicable to liquids with low concentrations of salts and particulates such as those found in normally encountered environmental pollution environments.

TABLE 1

| | Contact Angle | Hysteresis |
|---|---|---|
| Description | (degrees) | (degrees) |
| Hydrophylic | <45 | — |
| Hydrophobic | >45 and <150 | >10 |
| Superhydrophobic | >150 | <10 |

In general, a Lotus Effect surface arises when both of the following factors are achieved: the surface is covered with low surface free energy materials, and has a very fine structure. Low surface free energy materials provide a relatively high contact angle. The contact angle is a measure of the wettability of a surface with water. Readily wettable (hydrophilic) surfaces have relatively small contact angles, and non-wetting (hydrophobic) surface have relatively large contact angles.

Regarding surface structure, surfaces that are rough tend to be more hydrophobic than smooth surfaces, because air can be trapped in the fine structures, which reduce the contact area between the liquid and the surface, or water and solid. It is recognized that when a water drop is placed on a lotus plant surface, the air entrapped in the nanosurface structures prevents the total wetting of the surface, and only a small part of the surface, such as the tip of the nanostructures, can contact with the water drop. For the lotus plant leaves, the actual contact area is only 2-3% of a droplet-covered surface. This enlarges the water/air interface while the solid/water interface is minimized. Therefore, the water gains very little energy through adsorption to compensate for any enlargement of its surface. In this situation, spreading does not occur, the water forms a spherical droplet, and the contact angle of the droplet depends almost entirely on the surface tension of the water. The relationship between the surface water contact angle and the surface structural geometry (Wenzel roughness) can be given in Cassie equation:

cos θ_{A}=rf₁ cos θ_{Y}+f₁−1 Equation 1

where the parameter r is the ratio of the actual solid-liquid contact area to its vertical projected area (Wenzel roughness factor), θ_{A} is the apparent contact angle on the rough surface, and θ_{Y} is the contact angle on a flat surface as per Young's equation, f₁ is the solid surface fraction.

Although the Lotus Effect was discovered in plants, it is essentially a physicochemical property rather than a biological property. Therefore, it is possible to mimic the lotus surface structure. A Lotus Effect surface can be produced by creating a nanoscale rough structure on a hydrophobic surface with contact angles of over 90° (in situ bulk fabrication), coating thin hydrophobic films on nanoscale rough surfaces (surface fabrication), or creating a rough structure and decreasing material surface energy simultaneously (combination fabrication). To date, many methods have been developed to produce hydrophobic surfaces with nanoscale roughness.

Conventionally, a variety of methods have been developed to produce hydrophobic surfaces with nanoscale roughness. These methods include the fabrication of polymer nanofibers and densely packed aligned carbon nanotube films combined with fluoroalkylsilane coating, solidification of melted alkylketene dimer, anodic oxidation of aluminum with fluoroalkyltrimethoxysilane, immersion of porous alumina gel films in boiling water, mixing of a sublimation material with silica particles, and treating the fluorinated polymer film with different plasma techniques.

Superhydrophobic properties are desirable for many applications. For example, a durable superhydrophobic and self-cleaning coating would be invaluable from the high voltage industry to limit or prevent flashover, to the microelectromechanical systems (MEMS) industry to limit or prevent stiction, to the anticorrosion of metal coatings. Other applications for superhydrophobic surfaces are emerging all the time, such as the directed liquid flow in microfluidics, antifouling in biomedical applications, and transparent coatings in photovoltaics devices, just to name a few.

In regard to high voltage applications, superhydrophobic properties would help limit or even prevent the accumulation of contaminants on the surface of the insulators, which can produce a conductive layer when wet, which can then lead to an increase in leakage currents, dry band arcing, and ultimately flashover. Due to the self-cleaning properties of the surfaces, the contamination that is deposited on the surface can be easily picked up by water droplets falling or condensed on the surface.

The bulk of power delivery from the generating sites to the load centers is done by overhead transmission lines. To minimize line losses, power transmission over such long distances is more often carried out at high voltages (several hundred kV). The energized high voltage (HV) line conductors have to be physically attached to the support structures. Also, the energized conductors have to be electrically isolated from the support structures.

The device used to perform the dual functions of mechanical support and electrical isolation is the insulator. Since transmission lines are often in remote locations that are hard to reach, it is desirable that once a line has been constructed that it will work satisfactorily, without maintenance, for the expected life of the line, generally exceeding 30 years. The quality of raw materials, processing, design, and quality control of the insulator are all important.

In many parts of the world, insulator contamination has become a major impediment to the interrupted supply of electrical power. Contamination on the surface of insulators gives rise to leakage current, and if high enough, flashover. Conventional techniques have been applied to address this problem, including:

(1) Cleaning with water, dry abrasive cleaner, or dry ice can effectively remove loose contamination from insulator, but it is expensive, labor intensive and only a short term solution;

(2) Mobile protective coatings, including surface treatment with oils, greases and pastes, can prevent flashover, but have damaging results to the insulator during dry band arcing;

(3) Grease-like silicone coating components, usually compounded with alumina tri-hydrate (ATH), provide a non-wettable surface maintaining high surface resistance, and have been used as protective coatings for the past 30 years. A major strength of silicone grease lies in its ability to maintain a mobile water repellent surface, thereby controlling leakage current;

(4) Fluorourethane coatings were developed for high voltage insulators, but the field test was not successful, and its low adhesion to the insulators has been a problem; and

(5) Since 1970s, room temperature vulcanizing (RTV) silicone coatings have gained considerable popularity, and become the major products available in the market, such as Dow Corning's SYLGARD High Voltage Insulator Coatings (HVIC), CSL's Si-Coat HVIC, and Midsun's 570 HVIC. Service experience has indicated that of the various types of insulator coatings, the time between maintenance and RTV coating reapplication is the longest.

Yet, these conventional techniques do not prevent contamination, such as dust, accumulation on coating surfaces; thus, these serve only to manage the problem, and do not provide satisfactory performance in heavy contamination environments.

Insulators are used with transmission and distribution systems, including power transmission lines, for example at locations where the lines are suspended, and typically have voltages, AC and DC, from 5 kV to 800 kV. The term insulator as used herein includes typical distribution line insulators, for example, from low-voltage (LV) lines to extra-high voltage (EHV) lines. More specifically, the term includes LV lines, medium-voltage (MV) lines, wherein the voltage is usually between 2.4 kV and 69 kV, high-voltage (HV) lines, wherein the voltage is usually below 230 kV, and EHV, being lines operating at voltages of up to 800 kV, and stretching as long as 1000 km. High-tension direct lines are also included in this group.

Known insulators include ceramics, glass and polymeric materials. Ceramic and glass insulators have been used for over 100 years. The widespread use of polymeric insulators began in North America during the 1970s. A currently popular line of insulators are RTV silicone rubber high voltage insulator coatings.

Ceramic insulators generally include clay ceramics, glasses, porcelains, and steatites. The ceramic is produced from the starting materials kaolin, quartz, clay, alumina and/or feldspar by mixing the same while adding various substances in a subsequent firing or sintering operation. Polymeric materials include, for example, filled and unfilled composites, such as ethylene propylene diene monomer (EPDM) rubber and silicone rubbers/elastomers, and can include resins, such as epoxy, polyester and polyolefin based polymers, and copolymers).

A wide variety of manufacturing techniques can be employed to construct insulators of the desired shape. Some of the processes that are most often used include machining, molding, extrusion, casting, rolling, pressing, melting, painting, vapor deposition, plating, and other free-forming techniques, such as dipping a conductor in a liquid dielectric or filling with dielectric fluid. The selection process must take into account how one or both of the electrodes made from conductive material will be attached or adjoined to the insulator.

In long-term use, an insulator is subject to superficial soiling depending on the location at which it is used, which can considerably impair the original insulating characteristics of the originally clean insulator. Such soiling is caused, for example, by the depositing of industrial dust or salts, or the separating out of dissolved particles during the evaporation of moisture precipitated on the surface.

One problem afflicting high voltage insulators used with transmission and distribution systems includes the environmental degradation of the insulators. Insulators are exposed to environment pollutants from various sources. Pollutants that become conducting when moistened are of particular concern. Two major sources of environmental pollution include coastal pollution and industrial pollution.

Coastal pollution, including salt spray from the sea or wind-driven salt-laden solid material such as sand, can collect on the insulator surface. These layers become conducting during periods of high humidity and fog. Sodium chloride is a main constituent of this type of pollution.

Industrial pollution occurs when substations and power lines are located near industrial complexes. The power lines are then subject to the stack emissions from the nearby plants. These materials are usually dry when deposited, and then may become conducting when wetted. The materials will absorb moisture to different degrees. Apart from salts, acids are also deposited on the insulator.

High voltage lines can be exposed to both sources of pollution. For example, if a substation is situated near the coast, it will be exposed to a high saline atmosphere together with any industrial and chemical pollution from other plants situated in close proximity.

The presence of a conducting layer on the surface of an insulator can lead to pollution flashover. In particular, sufficient wetting of the dry salts on the insulator surface is required to form a conducting electrolyte. The ability of a surface to become wet is described by its hydrophobicity. Ceramic materials and some polymeric materials such as EPDM rubber are hydrophilic, that is, water films out easily on its surface. In the case of some shed materials for high voltage insulator application, such as silicone rubber, water forms beads on the surface due to the low surface energy.

When new, the hydrophobic properties of silicone rubber are excellent; however, it is known that severe environmental and electrical stressing may erode the beneficial hydrophobicity properties.

Current remediation techniques for environmental degradation of a high voltage insulator include washing, greasing, and coatings, among others. Substation or line insulators can be washed when de-energized or when energized. Cleaning with water, dry abrasive cleaner, or dry ice can effectively remove loose contamination from insulator, but it is expensive and labor intensive. It is not uncommon that washings involve shutting down the power once every two weeks in the winter, and once per week in the summer when doing this kind of maintenance. These common occurrences of de-energization simply are not preferable.

Mobile protective coatings, including oils, grease and pastes surface treatment, can prevent flashover, but have damaging results to the insulator during dry band arcing. While a thin layer of silicone grease when applied to ceramic insulators increases the hydrophobicity of the surface, pollution particles that are deposited on the insulator surface are also encapsulated by the grease and protected from moisture. Another disadvantage of greasing is that the spent grease must be removed and new grease applied, typically annually. Grease-like silicone coating components, usually compounded with ATH, provide a non-wettable surface and maintain high surface resistance. Thus, while greasing can greatly reduce maintenance costs when viewed against washings, substation personnel have to remove the old grease compounds from the equipment, and then re-apply the new grease compound annually.

Fluorourethane and silicone RTV coatings are also known. Room temperature cured silicone rubber coatings are available to be used on ceramic or glass substation insulators. These coatings have good hydrophobic properties when new. Silicone coatings provide a virtually maintenance-free system to prevent excessive leakage current, tracking, and flashover. Silicone is not affected by ultraviolet light, temperature, or corrosion, and can provide a smooth finish with good tracking resistance.

Silicon coatings are used to eliminate or reduce regular insulator cleaning, periodic re-application of greases, and replacement of components damaged by flashover. They appear to be effective in many types of conditions, from salt-fog to fly ash. They are also useful to restore burned, cracked, or chipped insulators.

SYLGARD is one type of silicone coatings, and is marketed to restrict the rise in leakage currents and protect the insulators against pollution induced flashovers. The cured SYLGARD coating has a high hydrophobicity. In addition, there are a certain percentage of polymer molecules that exist within the cured rubber as low molecular weight free fluid. These molecules are known as “cyclics”. The free fluids are easily able to migrate to the surface of the coating and, as pollutants fall on the surface, they in turn are encapsulated and rendered non conductive and somewhat hydrophobic.

If leakage currents are controlled, there will be no arcing. If there is an extreme weather event then it may be that, for a time, the SYLGARD coating cannot control the surface leakage currents. In this case SYLGARD also provides a high degree of surface arc resistance. Incorporated into the formulation is an ATH filler, which releases H₂O when it becomes hot, and consequently resists the degradative effects of high temperatures resulting from exposure of the coating to arcing.

Thus, none of the conventional techniques to limit contamination, such as dust accumulation on coating surfaces, provides satisfactory performance in heavy contamination environments. A need yet exists for a superior product that can minimize the maintenance necessary with conventional coatings. An HVIC that is self-cleaning and has a longer life than conventional coatings would be beneficial.

As previously discussed, there are other applications where superhydrophobic properties are desirable, beyond that of the high voltage industry. It is known that stiction is one of the major factors that limit the widespread use and reliability of micro-electromechanical systems (MEMS). The fundamental mechanism to prevent stiction is either increasing the surface roughness, or coating MEMS surfaces with hydrophobic materials.

In another application, it would also be beneficial to prepare superhydrophobic silicone/polytetrafluoroethylene (PTFE) films for biocompatibility in encapsulation of implantable microelectronics devices. At present, a variety of superhydrophobic surfaces have been fabricated from materials ranging from organic polymers (e.g., polystyrene, fluorinated polyelectrolytes, polypropylene) to inorganic materials (e.g., silica and alumina). Polydimethylsiloxane (PDMS) and polytetrafluoroethylene (PTFE) both have very low surface energies (˜21 mJ/cm² for PDMS and 18.5 mJ/cm² for PTFE). They have well established implant history due to their relatively inert and biocompatible properties. Silicone rubbers are the most widely used polymers in medical applications because of the strong Si—O—Si (siloxane) backbone, which provides enhanced chemical inertness and exceptional flexibility.

PTFE is highly hydrophobic, with undetectable water absorption. It would be beneficial to incorporate these two low surface energy biocompatible materials, i.e., PTFE nanoparticles in curable PDMS matrix, to create superhydrophobic films on a silicon wafer that was in the Cassie regime with the water contact angles around 160°. Such a film would suitable as a biocompatible coating for implantable microelectronic devices. Such a surface would be biocompatible not only due to the surface hydrophobicity, but also due to the surface structure (roughness), as such, biomaterials and bio-cells like protein or macrophage are not easy to adsorb on the surface. This is discussed in the following, herein fully incorporated by reference; Xiu, Y., et al. Superhydrophobic Silicone/PTFE Films for Biocompatible Applications in Encapsulation of Implantable Microelectronics Devices. in 56th Electronic Components and Technology Conference; 2006. San Diego, Calif.

Returning to the prospect of providing superhydrophobic coatings as a preferable surface treatment generally, surfaces with a combination of microstructure and low surface energy are known to exhibit interesting properties. A suitable combination of structure and hydrophobicity renders it possible that even slight amounts of moving water can entrain dirt particles adhering to the surface and completely clean the surface. It is known that if effective self-cleaning is to be obtained on an industrial surface, the surface must not only be very hydrophobic (Young's contact angle of over 90°, see Equation 2 hereinafter), but also have a certain roughness. Such surfaces are disclosed in, for example, WO 96/04123 and U.S. Pat. No. 3,354,022.

European Pat. No. 0 933 380 discloses that an aspect ratio of >1 and a surface energy of less than 20 mN/m are required for such self-cleaning surfaces. The aspect ratio is defined to be a quotient of a height of a structure to a width of the structure.

Other prior art references include PCT/EP00/02424, which discloses that it is technically possible to render surfaces of objects artificially self-cleaning. The surface structures, composed of protuberances and depressions, required for the self-cleaning purpose, have a spacing between the protuberances of the surface structures in the range of 0.1 to 200 μm and a height of the protuberances in the range from 0.1 to 100 μm. The materials disclosed therein include hydrophobic polymers or a durably hydrophobized material. Detergents must be prevented from dissolving the supporting matrix. As in the documents previously described, no information is given either on the geometrical shape or radii of curvature of the structures used.

European Pat. No. 0 909 747 teaches a process for producing a self-cleaning surface. The surface has hydrophobic elevations from 5 to 200 μm. A surface of this type is produced by applying a dispersion of powder particles and of an inert material in a siloxane solution, followed by curing. The structure-forming particles are therefore secured to the substrate by an auxiliary medium.

Methods for producing these structured surfaces are likewise known. For example, U.S. Pat. No. 5,599,489 utilizes an adhesion-promoting layer between particles and the bulk material. Processes suitable for developing the structures are etching and coating processes for adhesive application of the structure-forming powders, and also shaping processes using appropriately structured negative molds.

However, it is common to these methods that the self-cleaning behavior of the surfaces is described by a particular surface roughness. The roughness may be defined by a number of metrics, such as the Wenzel Roughness (Equation 1).

Plasma technologies are widely utilized for processing of polymers, such as deposition, surface treatment and etching of thin polymer films. The advantages of using plasma techniques to prepare the Lotus Effect coating include that plasma technologies have been extensively employed in surface treatment processes in the electronic industry. Fabricating the Lotus Effect coating on various surfaces with plasma can be easily transferred from research to scale up production. Further, plasma-based methods can be developed into a standard continuous/batch process with low cost, highly uniform surface properties, high reproducibility and high productivity.

For example, U.S. Ser. No. 10/966,963, the disclosure of which is incorporated herein by reference, discloses plasma technologies, including superhydrophobic coatings, and methods of applying Lotus Effect materials as a superhydrophobic protective coating for external electrical insulation system applications, as well as the method of fabricating/preparing Lotus Effect coatings. However, plasma technologies have been found disadvantageous in certain applications, with its attendant relatively high cost, requirement of special equipments, etc.

Another limitation of the known superhydrophobic art include that the surfaces are uni-modal, in that the size distributions (height or diameter), do not vary beyond a relatively small tolerance. It would be beneficial to provide a multi-modal surface structure for improved superhydrophobicity, and such a surface that does not require the use of experimentally cumbersome low pressure plasma post-treatment.

Further, known superhydrophobic surfaces are typically constructed with one chemical species. It would be beneficial to provide a multi-species system, having two or more widely different chemical species for improved long lifetime (decomposition of organic contamination that can not be easily cleaned by water droplets on the surface).

As yet another advantage, if the superhydrophobic effect could be provided at or near ambient temperatures and pressures, it would be desirable.

It can be seen that a need yet exists for a superior coating and method that ultimately provides a surface exhibiting Lotus Effect properties, including superhydrophobicity and self-cleaning.

### BRIEF SUMMARY OF THE INVENTION

The present invention comprises superhydrophobic surface coatings, and methods for forming same. The outer surface of a device can play a critical role in determining the reliability of the device. This is true for a wide range of applications, whether the application is a transmission line for power delivery, or used in MEMS, or for biocompatible application in encapsulation of implantable microelectronics devices.

A preferred surface for such devices should have one or more of the following properties: (i) water repellence—hydrophobicity; (ii) self cleaning or de fouling, (iii) chemical/physical inertness, (iv) longevity (under single and multi-factor ageing conditions), (v) beneficial adhesion to the substrate; and, (vi) mechanical robustness. It is convenient to describe the water repellency of surfaces in terms of the liquid contact angle that they make to the surface. The contact angle is a specific and fundamental property of the surface and the liquid in contact. The parameters used to describe this property include the equilibrium (after the normal “recovery effects” known in practical devices, as it is well known that on many practical insulators, the hydrophobicity is lower directly after multifactor exposure, and then increases (recovers) with time after removal from the multifactor environment) (i) contact angle—the angle an isolated drop makes with the surface; and, (ii) hysteresis—the difference in contact angle between the advancing and receding fronts of a moving isolated drop.

An alternate metric for water repellency is the time, at constant high AC voltage, that an inclined dielectric surface can sustain the high voltage in the presence of a continual flow of fluid, most usually water. The approach is the focus of work within Working Group WG D1-14 of CIGRE. The usual Weibull scale parameter (probability for 63.3% of the samples to fail) for the endurance tests for elastomeric (silicone) dielectric plaques is within the range 1-4 minutes. Surfaces with improved hydrophobicity (superhydrophobicity and higher hydrophobicity than the base) will display higher values of Weibull scale parameter than the untreated versions. These values might be expected to be a factor of two (2) or more higher than the base cases. The improved performance is also evidenced by increases in the Weibull scale parameter. Optimal water repellency is given by a combination of high contact angle and low hysteresis. See TABLE 1.

Superhydrophobic surfaces occur when structures of a defined size (height and diameter) are created at the correct surface density and distribution. The liquid drops on such a surface are constrained to the tops of these “pillar” by the specific surface energies of the pillar tops. Conventionally, such surfaces have been designed to have a single distribution of sizes (height and diameter), and can thus be described as uni-modal superhydrophobic surfaces. Additionally, conventional surfaces are constructed using but a single chemical species.

Furthermore, to attain the correct surface energy for the coating, it conventionally has been necessary for the coatings to be treated in a well-defined, low pressure plasma. This requirement is difficult to achieve within normal manufacturing operations. Although superhydrophobic surfaces can be created on polymers following aggressive plasma treatments, it has been found these surfaces rapidly degrade under the combined effect of water vapor condensation, elevated temperature and UV irradiation.

In a preferred embodiment, the present invention comprises an inorganic surface of improved hydrophobicity (typically superhydrophobic in nature) which is stable under harsh multi-factor ageing environments such as salt, moisture, and high temperature.

In another preferred embodiment, the present invention comprises an inorganic, stable and inert superhydrophobic surface that possess beneficial longevity (is stable over time). As is known, since UV initiates the aging process, the present invention can also be described as a UV-stable superhydrophobic surface.

For example, the present invention can comprise an inorganic, stable superhydrophobic surface, wherein stable is defined as the surface maintaining a contact angle of greater than 150 degrees after 1,000 hours of multi factor ageing tests. The surface is preferably UV-stable, wherein UV-stable is defined as the surface maintaining a contact angle of at least 150 degrees after 1,000 hours of a UV weathering test according to ASTM D 4329. A preferred surface of the present invention can maintain a contact angle of greater than 150 degrees after 5,500 hours of multi factor ageing tests, and more preferably, maintain a contact angle of greater than 162 degrees after such ageing tests. Such surfaces can be upon, for example, a dielectric substrate, or an insulating substrate.

The inorganic, multi-factor stable superhydrophobic surface can include a superhydrophobic surface with two or more widely separated size distributions (height or diameter), and can thus be described as a multi-modal superhydrophobic surface, including, for example, bi-modal and tri-modal. In addition, a sufficiently high contact angle is attained, such that the water repellence matches that of the conventional art, without recourse to the experimentally cumbersome low pressure plasma post-treatment.

Alternatively, or in combination, the inorganic, multi-factor stable superhydrophobic surface can include a superhydrophobic surface with two or more widely different chemical species. The size distribution of the species can cover a wide range. Such size distribution can cover a range defined by the ratio of the mean of the largest distribution divided by the mean of the smallest distribution, for example, from 0.05 to 50. Such superhydrophobic surfaces with two or more widely different chemical species can also be multi-modal superhydrophobic surfaces.

Preferably, coating species are electrically insulating, and include at least two or more of the following, among others: SiO₂, TiO₂, TeO₂, CeO₂, Al₂O₃, calcium carbonate, barium sulfate, calcium phosphate and hydroxyapatite.

In another preferred embodiment, the present invention comprises methods of forming an inorganic, stable superhydrophobic surface. For example, the present invention can comprise a method of forming an inorganic, stable superhydrophobic surface comprising mixing one or more precursors and a solvent to form a first solution, reacting over time a mixed solution to form a reacted solution, applying the reacted solution to a clean substrate, and gelling the reacted solution on the substrate to form the inorganic, stable superhydrophobic surface, wherein the mixed solution is the first solution. This process can include another preferred step after the step of mixing one or more precursors and a solvent to form a first solution, wherein the solution of mixed one or more precursors and a solvent is then mixed with an acid and water, which such solution is then processed through the above reacting, applying and gelling steps.

In various preferred embodiments of these methods of forming an inorganic, stable superhydrophobic surface, eutectic liquids can be used, the one or more precursors are organometallic, the solvent is an alcohol, the step of mixing the one or more precursors and the solvent to form the first solution is run at a temperature of between 10-80° C., the acid is one of hydrochloric acid, sulfuric acid, phosphoric acid, chromic acid, oxalic acid, formic acid, and acetic acid, the step of mixing the acid and water in the first solution to form the second solution is run at a temperature of between 10-40° C., the step of reacting over time the mixed solution to form the reacted solution runs between 30 minutes and 8 hours, and the step of applying the reacted solution to the clean substrate is by one or more of dipcoating, spincoating and spray coating.

These methods of forming an inorganic, stable superhydrophobic surface can further include a step of cleaning the substrate prior to the step of applying the reacted solution to a clean substrate, wherein the step of cleaning the substrate includes one or more of Piranha solution cleaning, alkali/H₂O₂ cleaning, UV/ozone cleaning, and mechanical abrasion of the substrate. Further additional steps can include one or more of the fine-tuning the strength of the resultant inorganic, stable superhydrophobic surface by adjusting the ratio of the precursors if more than one precursor is used, the firing of the surface to strengthen the surface structure, and the post-treatment of the structured surface for improved hydrophobicity.

In yet another preferred embodiment, the present invention is a surface and method of forming a surface, wherein upon a coating, the surface achieves superhydrophobicity without any further surface treatment, herein termed “autophobicity”. For example, when using a suitable surface (such as that from the sol-gel process) to test coat the surface of silicone parts, the surfaces achieved superhydrophobicity without any further surface treatment. After the silica particles were dipcoated or painted on the silicone surface, and after a certain period of time, the surface changes from hydrophilicity, to hydrophobicity, and finally to superhydrophobicity.

The present invention further includes a surface and method of forming a surface that has the beneficial characteristic of the recovery of hydrophobicity.

In another preferred embodiment, the present invention improves the superhydrophobic effect (higher contact angle and lower hysteresis) through the post-treatment of a surface that displays a contact angle greater than 150°, with a coupling agent. The effectiveness of the coupling agent is enhanced if the agent contains chemical elements that are known to be hydrophobic in nature. Silanes such as trichloro or tri(m)ethoxyl silanes are preferred. The present treatment overcomes the drawbacks of conventional techniques, in that it may be accomplished at or near ambient temperatures and pressures. The ambient nature of the present treatment means that many geometries or sizes of device/insulator can be treated, thereby removing significant limitations of prior art techniques. The present treatment is compatible with one or more chemical species, and uni- or multi-modal superhydrophobic surfaces.

In a preferred form, the present invention comprises a method to prepare a superhydrophobic coating as a (super) protective coating for a wide range of devices. Coatings of this type can have a wide range of uses, and the substrate to which the same is applied can be varied, including polymers, ceramics, metals and glass. In particular, although not necessarily exclusive, by coating and etching polymer coating materials, the present invention provides a method to prepare superhydrophobic coatings, and prevent the problems of conventional coating systems.

In a preferred embodiment of the present invention, the dipcoating process can be used to coat the surface. The effects of the present invention are additive for subsequent coatings, it is believed due to the in-filling of the nanoparticles on the coatings structures. It has been found that repeated coatings develop an enhanced surface. For example, more than two (2) coatings, and more beneficially more than four (4) coatings, have been found preferred. In the repeat coatings, different methods of application (casting, dip coating, doctor blading, painting, spraying, etc.) may, if desired, be employed from those first employed.

The present invention preferably uses a sol-gel process to synthesize multi-modal, multi-species superhydrophobic surfaces in situ on preferably a dielectric surface.

Examples of dielectric surfaces include, among others: polymeric (filled and unfilled, thermoset and thermoplastic), glassy, ceramic, fresh (unexposed), aged (exposed such that the original water repellent properties have been degraded), and retreated to recover some water repellent properties.

These and other objects, features and advantages of the present invention will become more apparent upon reading the following specification in conjunction with the accompanying drawing figures.

### BRIEF DESCRIPTION OF THE FIGURES

FIGS. 1A and 1B illustrates examples of the Lotus Effect. FIG. 1A shows water droplets on a wood surface treated for extreme water-repellant superhydrophobicity. FIG. 1B shows a water droplet on the leaf of the Asiatic crop plant absorbing dirt particles as it rolls.

FIG. 2 is a schematic representation of contact angle and hysteresis.

FIG. 3 is a schematic of the silica/PMMA templating process for dip coating or painting.

FIG. 4 illustrates the chemical structures of KPS, SDS & Triton X reagents.

FIG. 5 illustrates pore distribution of silica coatings from dipcoating.

FIG. 6 shows the surface morphology of porous silica templated by PMMA and Triton X 100.

FIG. 7 shows a silica surface prepared with sequentially dipping in silica sol and PMMA emulsion.

FIG. 8 illustrates two views of the surface of a copper template.

FIG. 9 shows the silicone surface templated with copper foil with vacuum treatment and the subsequent contact angle.

FIG. 10 shows the templated silicone surface without vacuum treatment.

FIG. 11 shows the expansion of aluminum during anodic oxidation. On the left, the level of the un-oxidized metal surface is depicted.

FIG. 12 is an SEM image of an alumina templating surface after treatment with PFOS: contact angle (175.6°).

FIGS. 13A and 13B show an AFM image and height analysis of the nanostructure on the surface of an alumina template (average is around 60-70 nm).

FIG. 14 shows the UV degradation of a polymeric superhydrophobic surface, being a polybutadiene surface treated with SF₆ plasma (150 W, 10 minutes).

FIG. 15 shows the EDX of the degraded superhydrophobic surface of FIG. 14.

FIG. 16 is a graph illustrating the degradation of superhydrophobic polybutadiene with different UV stabilizers.

FIG. 17 shows the generalized reaction mechanism for various precursors.

FIG. 18 shows the chemical structure of an TMOS-IBTMOS surface.

FIG. 19 is a SEM image of the surface structure of the TMOS-IBTMOS (see FIG. 18) films on micro slide; contact angle: 162°, hysteresis: <5°.

FIG. 20 shows the surface chemical structure of TFPS-TEOS.

FIGS. 21A-D are SEM micrographs of the TFPS-TEOS (see FIG. 20) surfaces for different reagent ratios.

FIGS. 22A-D are EDX analyses of the surface elements for the same surfaces shown in FIGS. 21A-D.

FIG. 23 shows the surface nanostructure, by SEM, of TFPS:TEOS=3:1 film.

FIG. 24 is a QUV stability test of the surface shown in FIG. 23 with a glass substrate.

FIGS. 25A and 25B are the initial contact angle and hysteresis for the structures shown in FIGS. 19 and 21.

FIG. 26 shows contours of final particle diameters (nanometers) as obtained by reacting 0.3 mole/liter of tetraethyl silicate with various concentrations of water and ammonia in ethanol following Equation 7.

FIGS. 27A-D show monodisperse silica spheres produced using different conditions (primarily acidity) by varying ammonia content in the reaction.

FIG. 28 shows multi-modal (bi-modal) sized distribution of silica particles grown on an insulating surface (silicone rubber)—mean large 470 nm, mean small 150 nm (dipcoating sequentially in two ethanol dispersions (first, 470 nm dispersion, second, 150 nm dispersion)); contact angle: 140° after PFOS treatment.

FIG. 29 shows multi-modal (tri-modal) sized distribution of silica particles grown on an insulating surface (silicone rubber): mixture of 350 nm, 550 nm, and 850 nm particles.

FIG. 30 shows multi-modal (quadra-modal) sized distribution of silica particles grown on an insulating surface (silicone rubber): mixture of 350 nm, 450 nm, 550 nm, and 850 nm particles.

FIG. 31 shows the relative position of the measured contact angle of different surfaces. The small triangles joined by a line show the multi-modal surfaces. The large triangles represent the superhydrophobic (darker) and hydrophobic (lighter) limits.

FIG. 32 shows the relative position of the measured hysteresis of different surfaces. The small triangles joined by a line show the multi-modal surfaces. The large triangle represents the superhydrophobic (dark) limit.

FIG. 33 shows polydisperse silica particles.

FIGS. 34A and 34B are PFOS-treated particles of TiO₂ and SiO₂, (A) titania/silica—big/small, contact angle: 169°; (B) silica/titania—big/small, contact angle: 165°.

FIG. 35 shows the autophobicity (improvement in hydrophobicity with resting time) of silicone surfaces (the effect applies to all silicone surfaces).

FIGS. 36A and 36 show bi-modal particles (SiO₂/TiO₂) improving the silicone surface (A) contact angle: 167.8°, hysteresis 6.7; (B) the surface treated with PFOS.

FIG. 37 is an SEM image of a silicone slab surface coated with bi-modal particles.

FIG. 38 shows the relative position of the measured contact angle of different surfaces.

FIG. 39 shows the relative position of the measured hysteresis of different surfaces.

FIGS. 40A and 40B illustrate a water droplet on the microscope slide surface, (A) before Piranha solution treatment, contact angle: 38.4°, and (B) after Piranha solution treatment, contact angle: 8.3°.

FIG. 41 is the general formula of the silanes used for the silica surface hydrophobic treatment.

FIG. 42 is a schematic of the process of silane monolayer formation.

FIG. 43 shows the effect of the silane carbon chain length (Rf in FIG. 41) on contact angle of a glass slide. Untreated, the contact angle is 50°.

FIG. 44 shows the effect of PFOS treatment time on the contact angle of a glass slide: 10 mM concentration of PFOS in Hexane.

FIG. 45 shows the effect of PFOS concentration on a glass slide, 30 minute treatment, on the contact angle.

FIG. 46 shows a porous silica surface treated with (heptadecafluoro-1,1,2,2 tetrahydrodecyl) trichlorosilane (HFDS) (10 carbon chain); contact angle: 172°, hysteresis: 2°.

FIG. 47 illustrates the results of a QUV weathering test according to ASTM D 4329 on the contact angle of a post-treated silica surface on a glass substrate.

FIG. 48 illustrates results of contact angle measurements.

FIG. 49 illustrates results of hysteresis measurements.

FIG. 50 illustrates in a chart the many beneficial aspects of coprecursors, autophobicity, post-treatment and multi-modalities/species of the present invention.

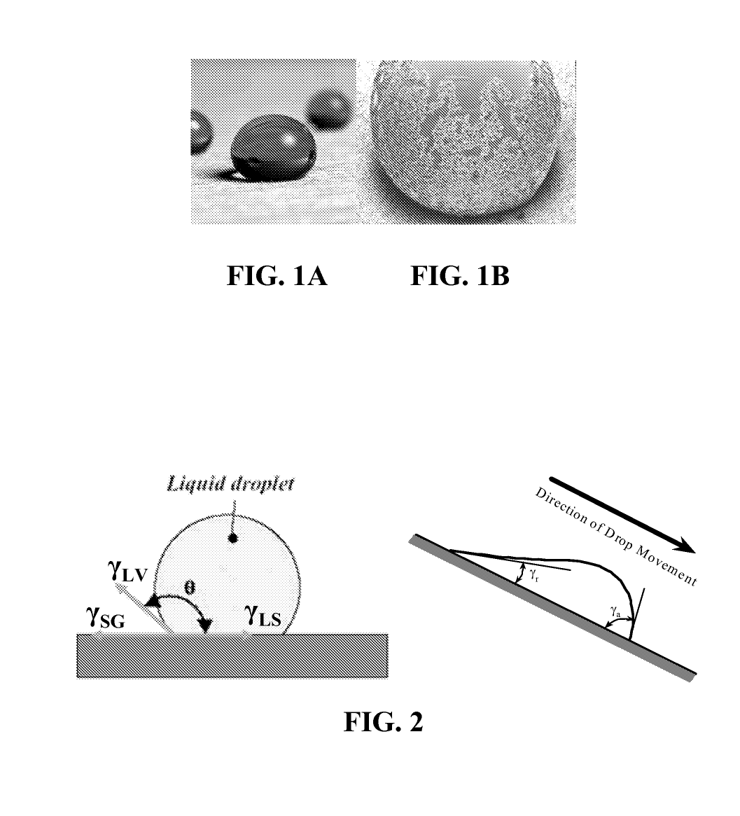

### DETAILED DESCRIPTION OF PREFERRED EMBODIMENTS

The present invention comprises superhydrophobic surface coatings, and methods for forming same.

The present invention comprises an inorganic, stable under multi-factor ageing conditions, superhydrophobic surface. The surface preferably has a contact angle greater than approximately 150°, and a hysteresis below approximately 10°. The inorganic material can be selected from a group including, for example, germanium, gallium arsenide, silicon (oxide), titanium (oxide), cerium oxide, aluminum (oxide), copper (oxide), zinc oxide, indium tin oxide (derivatives). In preferred embodiments, the inorganic materials can be Si, Al or copper. The surface is multi-factor stable in that, multi-factor UV weathering tests according to ASTM D 4329 showed that the resulting surface retained a contact angle greater than approximately 150°, and more preferably 162°, after approximately 1,000 test hours. The surface preferable can maintain the over 150° contact angle even after 5,500 test hours, and a hysteresis below 10°.

The present invention can comprise a first method of forming an inorganic, multi-factor stable superhydrophobic surface with the following steps: mixing two precursors and a solvent to form a first solution; mixing an acid and water in the first solution to form a second solution; reacting over time the second solution to form a reacted second solution; applying the reacted second solution to a clean subsurface; and, gelling the reacted second solution on the subsurface to form the inorganic, multi-factor stable superhydrophobic surface. The strength of the resultant inorganic, multi-factor stable superhydrophobic surface preferably can be fine-tuned by adjusting the ratio of the precursors.

The precursors can be selected from the group including, for example, organometallic, and more preferably, for example, tetra organometallic and tri organometallic. The solvent is preferably from the group of, for example, alcohol, more preferably ethanol. The two precursors and the solvent are preferably mixed in a temperature range of 10-80° C.

The acid used in this method can be selected from the group including, for example, hydrochloric acid, sulfuric acid, phosphoric acid, chromic acid, oxalic acid, formic acid, and acetic acid. The acid and the water are preferably mixed in a temperature range of 10-40° C.

The reaction time of this method is preferably in the range of 30 minutes to eight (8) hours.

The reacted second solution can be applied to the clean subsurface by, for example, dipcoating, spincoating, painting, or spray coating.

The subsurface can be cleaned by one or more of the following steps, including piranha solution cleaning and alkali/H₂O₂ cleaning, UV/ozone cleaning, or via mechanical abrasion of the surface.

The reacted second solution can be gelled to the subsurface by, for example, base catalyzed reactions.

The present method can further include a firing process to strengthen the surface structure, and/or a post-treatment of the structured surface for improved hydrophobicity.

The present invention can comprise a second method of forming an inorganic, multi-factor stable superhydrophobic surface, utilizing nanoparticles as sacrificial templating agents. This method can comprise many of the steps of the first method, or more preferably the following steps: preparation of silica sol by typical acid catalyzed hydrolysis of tetraethoxy silane (TEOS) or tetramethoxy silane (TMOS); preparation of polymer nanoparticles from typical water emulsion polymerization, e.g. (poly(methyl methacrylate) (PMMA) or polystyrene (PS)); mixing the two preparations together or mixing the second preparation with a commercially available silica sol or metal oxide sol; dipcoating or spincoating to form films on substrates; gelling the solution on the surface to form the composite films; and, firing at an elevated temperature to decompose the polymer nanoparticles to form porous thin film. After these steps and preferably after post-treatment by coupling agents, an inorganic, multi-factor stable superhydrophobic surface results.

The precursors, solvents, and temperature ranges of this second method can be similar to the first method. Further, the firing process to strengthen the surface structure preferably is run at between 300-700° C. This second method preferably includes the post-treatment of the structured surface for improved hydrophobicity, and the sequential dipcoating in the as derived sol and polymer nanoparticle emulsion can also be employed to generate the surface structures.

The present invention can further comprise a third method using low vapor pressure liquids (a eutectic liquid mixture). Eutectic liquids are a group of liquids that show extremely low melting points upon mixing of two or more different high melting point agents. One group includes metal halides/substituted quaternary ammonium salt mixtures, for example, Li, Be, Na, Mg, Al, K, Ca, Ti(IV), V, Mn, Co, Ni, Ga(III), Y(III), Zr(IV), Mo(V), Ag, Cd(II), In(III), Sb(III), Hf(IV), W(IV), Au(III), Hg(II), Pb(II), Bi(III), Tin(II), Fe(III), Zinc(II), chromium(III), chloride, and bromide; urea(ethylene glycol)/quaternary ammonium salt (e.g., choline chloride) mixtures. The third method uses eutectic liquids as solvent and templating agents for the creation of surface structures by ambient spincoating, dipcoating or a spray coating method using sol-gel technology.

The sol-gel process temperature preferably is in the range of 10-100° C., and the reaction time preferably in the range of ten (10) minutes to one (1) week. After gelation, the liquid can be removed by, for example, solvent extraction, thermal decomposition, oxidation or evaporation at elevated temperatures. An ultra thin film will be formed, and a nanorough surface results due to the exposure of the structured gel on the surface. In one embodiment, the gelation time is in the range of less than one (1) hour to one (1) week. Post-treatment of the surface can be conducted to form superhydrophobic surfaces by implantation of self-assembled monolayers (SAMs).

In another preferred embodiment, the present invention comprises the manufacture of a superhydrophobic surface having a packing of particles defined by surface roughness, which can be uni-modal, or multi-modal. A method to prepare such a surface can be the sol-gel process. In a preferred form, this process does not necessarily require plasma treatment on polymeric insulations. Precursors used in the preparation of the surface can be selected from the follow groups, for example, organosilicate, organotitanate, organoaluminate, alkoxides of boron, and alkoxides of cerium. The sol-gel process involves the formation of inorganic nanoparticles under certain reaction conditions. A preferably temperature range is 10-80° C. The solvent can be alcohol.

After applying the coating on the surfaces, rough surface structures will be formed by the nanoparticles on the surface. The solvent evaporation needs to be controlled to prevent too densely packed nanoparticles (and resultantly not superhydrophobic). After a post-treatment, the surface will become superhydrophobic, self-cleaning and multi-factor stable.

A preferable particle size ranges from 30 nm to 5 μm. On some specially-designed surfaces, a post-treatment may not be necessary, and after coating of the nanoparticles, the surface can itself gain the superhydrophobicity from the underlying layers. After the damage or depletion of the topmost layer by the action of multi-factor ageing, the surface can recover to superhydrophobicity from the underlying layers.

In a multi-modal embodiment of this particle packing invention, the precursors used in the preparation of the surface can be selected from the follow groups, for example, organosilicate, organotitanate, organoaluminate, alkoxides of boron, and alkoxides of cerium. The process involves the formation of inorganic nanoparticles under certain reaction conditions, and therefore the size of nanoparticles can be well controlled. Preferably temperature ranges include 10-80° C., and the process utilizes an alcohol solvent is alcohol.

Mixing different (>2 particle size distribution) nanoparticles together form the multi-modal nanoparticles. Thus, after applying the coating on surfaces, rough surface structures will be formed by the nanoparticles on the surface. After a post-treatment, the surface will become superhydrophobic, self-cleaning and multi-factor stable.

In another preferred embodiment, the present invention comprises the manufacture of a superhydrophobic coating comprising multi-species particles. The manufacture of surfaces using multi-species can use the sol-gel process. In a preferred form, this process does not necessarily require plasma treatment on polymeric insulations.

Precursors used to form such a coating can be selected from the following group, for example, organosilicate, organotitanate, organoaluminate, alkoxides of boron, and alkoxides of cerium. This process involves the formation of inorganic nanoparticles under certain reaction conditions, and the temperature ranges and solvents are similar as previously disclosed.

Preparation of Nanoparticles is Under Controlled Conditions, for Example, Base, Salt, temperature and water. The preparation of the core-shell structure can be from seeded nanoparticle growth. Preparation of raspberry structures (multi-species) is through the addition of precursors from different species by controlling the time of addition of the second precursor, or the addition of surface functional groups for bonding between two different nanoparticles. Alternatively, different nanoparticles can be mixed together to form nanoparticles of multi-species. Preferably particle sizes range from 30 nm to 20 μm.

In another preferred embodiment, the present invention comprises a near-ambient temperature surface treatment using a coupling agent applied to a surface to increase the contact angle and decrease the hysteresis. This embodiment can utilize the sol-gel process, and can be uni-modal or multi-modal, and uni-species or multi-species. The process includes the use of a coupling agent to increase the contact angle and decrease hysteresis. This process is especially useful for glass and ceramic surfaces. The surfaces have original contact angles>40°, more preferably >90°, and more preferably >140°.

In this embodiment, near ambient preferably means temperatures of <200° C. and ambient pressure. The coupling agent can be selected from the group, for example, of (fluoro)alkyl silane or phosphate ester or (fluoro) alkyl carboxylic acid, and more specifically, the coupling agent is fluoroalkyl silane (trichloro-(1H,1H,2H,2H-perfluorooctyl) silane (PFOS)).

As is evident, the present invention comprises technologies that can create a surface/coating that does not require aggressive processing, and is stable. Such techniques include: the sol-gel process, providing a relatively simple and practical chemistry that can be used to create superhydrophobic surfaces, and not requiring a separate treatment to make them superhydrophobic; templating, which shows the promise of the sol-gel process, with the benefits of post-treatment to modify the surface energy by low surface energy moiety in the coupling agents, and the inherent stability of oxide surfaces; multi-modal (size) and multi-species embodiments that were seen to significantly increase the superhydrophobicity; and, post-treatment, which showed improved superhydrophobicity on polymer surfaces, and beneficially activates the sol-gel surfaces on glassy substrates.

A preferred superhydrophobic surface coating according to the present invention includes many beneficial attributes, including that it: is stable under harsh environmental conditions; has good compatibility with the surface upon which it is applied, for example, silicone and porcelain—glassy; remains adhered to the surface after expansion and contraction of the underlying device; is capable of application in a simple and practical way; does not degrade in the environment it is used in; and, brings practical benefits to the operation of the underlying device. In addition, the coating preferably both inhibits the formation of a continuous film of water, and removes dust with the high water flow on the surface.

The present invention can comprise a sol-gel process to manufacture superhydrophobic surfaces in situ. In a preferred form, this process uses a plasma treatment to enhance the surface compatibility for reliable superhydrophobicity.

The present invention can further comprise utilizing a surfactant (cationic, such as cetyl trimethylammonium chloride (CTAB), anionic such as sodium dodecyl sulfate (SDS), or nonionic such as pluronic (PO)ₓ(EO)_{y}(PO)_{z}).

As described, the present invention can comprise many innovative methods to form the surface, including utilizing a low vapor pressure liquid (eutectic liquid mixture formed by the mixing, either as a single step within the formulation or as a pre mix, of two or more solid species with high melting points that leads to a dramatically reduced melting point of the mixture), as a solvent/solvent co agent and templating agent, wherein polymeric silica sols can be synthesized by acid/base catalyzed reaction.

During the film formation process, the solvent stays in place without appreciable loss. It is then gelled under a base (ammonia hydroxide) environment to form a strong film. The density of the film can be reduced after extraction of the eutectic liquid.

Correspondingly, the index of reflection can be tuned to form an anti-reflective layer for enhanced transparency. The low pressure liquid can also act as a template to form mesopores in the film that further reduce the density, dielectric constant, and refractive index.

After the eutectic liquid is extracted with ethanol, hexane and dried under controlled conditions, the surface can be treated with silanes, and superhydrophobic self-cleaning and multi-factor resistant films are thereafter produced. Alternatively, the eutectic liquid can be burned out at elevated temperature to form porous silica films.

In yet another preferred embodiment, the present invention comprises achieving superhydrophobocity by incorporating hydrophobic groups, such as hydrocarbon and fluorocarbon into/on inorganic material during or after a two step acid/base catalyzed sol-gel processing method, which is applied to make microstructure surfaces.

In a first method, a sacrificial polymer emulsion with specific surfactants is used to template and control the two scale distributed pores in the silica. The polymer particle size can be well controlled over the range of, for example, 50-500 nm during the emulsion polymerization. The formation of mesospores between 5-30 nm can then be controlled by self assembly of the surfactants.

The polymer and surfactants are then decomposed at elevated temperatures to generate the desired pores. This superhydrophobic coating can easily be created by dipcoating the object in the sol/polymer solution, firing the resulting structure, and subsequently undergoing a post-treatment to form SAMs. The film thinness can be controlled by the dipping rate and the concentration.

In a second method, a coprecursor sol-gel solution is applied to the substrate, where at least one precursor has hydrophobic groups (for example, a hydrocarbon chain or a fluorocarbon chain) attached to the Si atom. A specific reaction procedure is used in order to form well-ordered particle structures.

The two scale roughness can be created by the silica nanoparticle formed and the pores due to phase separation, because of the presence of the hydrophobic groups. For this method, the dipcoating environment needs to be relatively tightly controlled in order to control the solvent evaporation rate. The film strength can be fine-tuned by adjusting the ratio of the precursors and the dipcoating conditions.

For both of these methods, the firing process can be applied in order to further strengthen the film. After the firing process, a SAM treatment can be applied. Generally, the SAM can be fluoro/hydrocarbon trichlorosilane, fluoro/hydrocarbon trimethoxysilane or fluoro/hydrocarbon triethoxysilane. The fluorocarbon or hydrocarbon chain has 1-18 carbons, more preferably 10-18 carbons.

A specific nonpolar solvent can be selected, and a post two-stage thermal treatment applied, in order to form strong SAMs and make low surface energy coatings.

### Metrics For Surface Wetting and Particle Adhesion on Surfaces

The wetting of a solid with water, with air as the surrounding medium, depends on the relation between the interfacial tensions water/air, water/solid and solid/air. The ratio between these tensions determines the contact angle of a water droplet on a given surface, and is described by Young's equation (Equation 2). If a droplet is applied to a solid surface, it will wet the surface to a certain degree. At equilibrium, the energy of the system is minimized, which can be described by the Young's Equation:

$$cos θ = \frac{{γ}_{S V} - {γ}_{S L}}{{γ}_{L V}} \qquad Equation 2$$

where γ_{SL}, γ_{SV}, and γ_{LV} are the interfacial free energy per unit area of the solid-liquid (SL), solid-vapor (SV), and liquid-vapor (LV) interfaces, respectively. θ is the contact angle for a smooth surface.

Young's Equation 2 can only be applied to a flat, smooth surface, yet such a surface rarely existing for solids. As previously discussed, when a water drop is placed on a lotus plant surface, the air entrapped in the nanosurface structures prevents the total wetting of the surface, and only a small part of the surface, such as the tip of the nanostructures, can contact with the water drop. Air is enclosed between the wax crystalloids, forming a composite surface. This enlarges the water/air interface while the solid/water interface is minimized. Therefore, the water gains very little energy through adsorption to compensate for any enlargement of its surface. In this situation, spreading does not occur, the water forms a spherical droplet, and the contact angle of the droplet depends almost entirely on the surface tension of the water.

As previously discussed, the contact angle at a heterogeneous surface, and thus the one that is measured in practice can be described by Cassie's equation, Equation 1, where f is the remaining area fraction of the liquid-solid interface, and r is the Wenzel roughness ratio (or ratio of the real surface to the projected surface) of the wet area. Due to the different growing/treatment mechanism, the f and r can be very different for the Lotus Effect surfaces, leading to difference in water contact angle even if the surface chemistry is similar.

Besides the water contact angle, the hysteresis should also be considered in determining the surface hydrophobicity. The sliding angle and driving force needed to start a drop moving over a solid surface can be described via Equations 3 and 4, respectively:

$$\begin{matrix}sin α = \frac{{γ}_{L V} ( cos {θ}_{R} - cos {θ}_{A} ) w}{m g} & Equation 3 \\ F = {γ}_{L V} ( cos {θ}_{R} - cos {θ}_{A} ) & Equation 4\end{matrix}$$

In Equation 3, α is the sliding angle, m is the weight of the water droplet, w is the width of the droplet, γ_{LV} is the surface tension of the liquid, and the θ_{A} and θ_{R} are the advancing and retreating contact angles, respectively. In Equation 4, F is the critical line force per unit length of the drop perimeter. These equations indicate how the difference between the contact angles on a sloping surface (the hysteresis) affect the water repellence (hydrophobicity).

FIG. 2 is a schematic representation of contact angle and hysteresis. Compared with the superhydrophobicity of the Lotus Effect, the mechanism of self-cleaning is seldom studied. In fact, the self-cleaning can be achieved if two conditions can be met:

(1) The surface is superhydrophobic so that water drops have very large contact angle and small sliding angle; and

(2) The adhesion between the water drop and dust particles is greater than the adhesion between the surface and dust particles.

Adhesion of two components, such as adhesion of dust or dirt to a surface, is generally the result of surface-energy-related parameters representing the interaction of the two surfaces which are in contact. In general, the two contacted components attempt to reduce their free surface energy.

Strong adhesion is characterized by a large reduction in free surface energy of two adhered surfaces. On the other hand, if the reduction in surface free energy between two components is intrinsically very low, it can generally be assumed that there will only be weak adhesion between the two components. Thus, the relative reduction in free surface energy characterizes the strength of adhesion. And it was described by the Laplace-Dupre equation with work of adhesion (wₐ)

wₐ=γ(1+cos θ) Equation 5

where γ is the surface tension of liquid that is in contact with the surface and θ is the Young's contact angle.

Usually dust particles include materials having higher surface energies than the surface materials, they are generally larger than the surface microstructure, and they just contact with the tips of these microstructures. This reduced contact area minimizes the adhesion between the lotus leaf surface and dust particles, so the particles can be picked up and removed from the leaf surface by the water droplet, which is contacting the whole area of the particle surface. Therefore, it is likely that hydrophobic particles are less likely be removed by water droplets than hydrophilic dust particles on a lotus leaf, and small particles, which have a size close to or even smaller than the microstructures, possibly will be pinched in the microstructures, instead of being removed by water droplet.

### Methods for the Preparation of Lotus Effect Surfaces

Several methods for the preparation of Lotus Effect surfaces are disclosed, including templating, sol-gel, multi-modal, multi-species, pre-treatment, and post-treatment.

Templating Technology

Templating in the context of these surfaces means using one material (nanoparticle or surface micron/nanostructure) as a template to generate microstructures in another material. Two methods include:

(1) sacrificial polymer (polymethyl methacrylate, ((PMMA)) nanoparticle templating; and

(2) rough surface imprinting of a silicone surface.

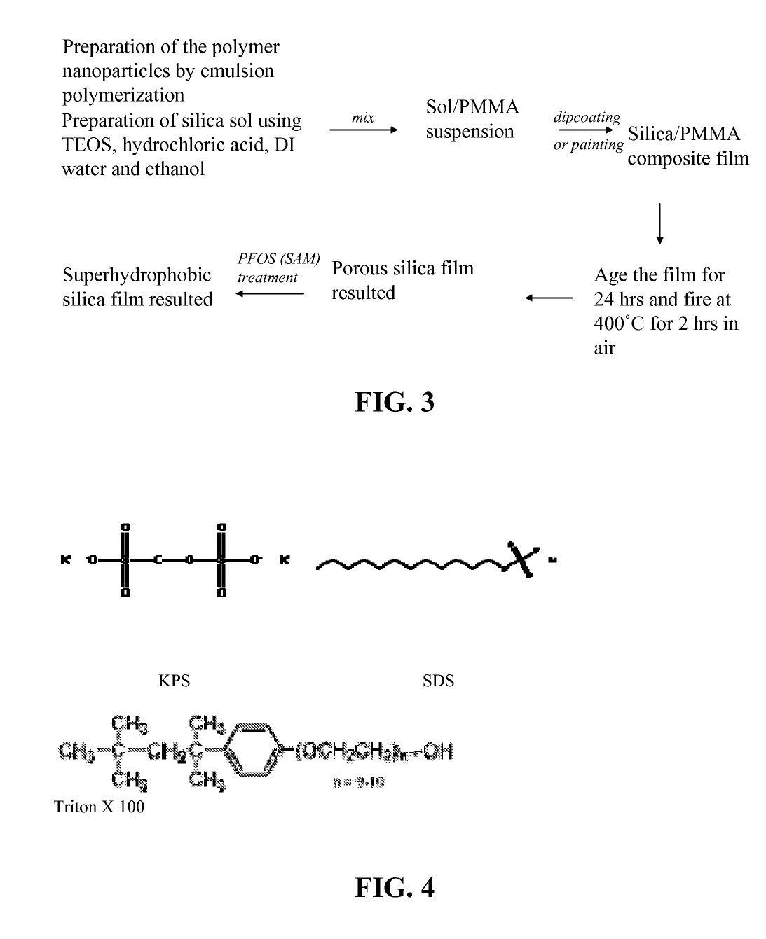

In templating by polymer emulsion suspension, focus is drawn on a PMMA/surfactant emulsion particle mixture that is coated on the insulator surface. Here, templating refers to using sacrificial materials (PMMA) to generate porous materials (silica). The PMMA is treated with extreme conditions to leave a porous substrate. This process is shown schematically in FIG. 3.

A first step is to prepare the nano PMMA particles. This can be done with emulsion polymerization conducted by the control of the reaction conditions and formulation. The synthesis of silica sol, accomplished using acid catalyzed hydrolysis and condensation, can be employed in order to first make linear and branched silica without gelation (for longer shelf life of the mixture). Then, three components (nanoparticle emulsion, the silica sol and a surfactant) are mixed. The mixture could be applied by either dipcoating or painting a thin film formed on the insulator surface (a microscope glass slide can be used) by evaporation of solvent and water.

The preparation of the PMMA polymer emulsion can use methyl methacrylate (MMA) monomer, initiator potassium persulfate (KPS), surfactant, and sodium dodecyl sulfate (SDS). Triton X can be added in order to generate a mesoporous structure. The structures of KPS, SDS, and Triton X reagents are shown in FIG. 4. TABLE 2 provides a polymerization formulation example, with a temperature at 80° C., stirring at 500 rpm, and a reaction time of two (2) hours:

TABLE 2

| MMA | 100 (parts by weight) |
|---|---|
| KPS | 3 |
| SDS | 3 |
| TRITON X 100 | 1 |
| H₂O | 600 |

The pores give the required roughness, thus to understand how this technology operates, it is important to measure the pore structure. In order to characterize the porous film, the Brunauer-Emmett-Teller (BET) surface area measurement method was conducted using a Gemini 2375, Micrometrics device. In the measurement, the film on glass slides was measured without getting the films off the surface. The BET equation is:

$$\frac{\frac{p}{{p}^{0}}}{n ( 1 - \frac{p}{{p}^{0}} )} = \frac{1}{{n}_{m} c} + \frac{c - 1}{{n}_{m} c} \frac{p}{{p}^{0}} \qquad Equation 5$$

where p is the vapor pressure, p⁰ is the saturation vapor pressure, n is the adsorbed molecules in mole, nₘ is the monolayer capacity in mole, c is a constant that is temperature dependent. Through the Kelvin equation, the following is provided:

$$RT ln \frac{p}{{p}^{0}} = - \frac{2 γ {V}_{m}}{r} \qquad Equation 7$$

where r is the curvature of pores, Vₘ is the molar volume of adsorbate (nitrogen in this example), and γ is the surface tension of the nitrogen at the temperature. When the vapor pressure p is known, the pore radius can be calculated according to the Kelvin equation, and thus the pore diameter and its distribution can be measured.

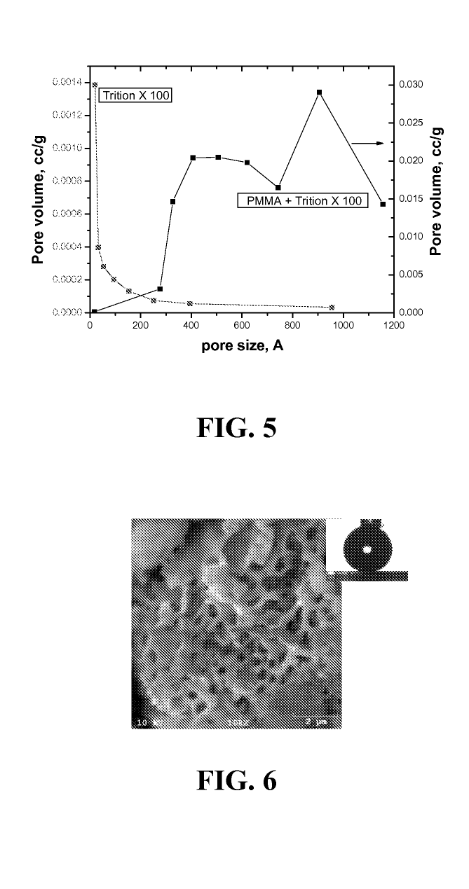

The results are shown in FIG. 5, illustrating the pore distribution of silica coatings from dipcoating, according to nitrogen adsorption by the Kelvin equation; templating agent: 1) Triton X 100; and 2) PMMA emulsion and Triton X 100.

FIG. 5 shows that for the templating of PMMA and Triton X 100, the pore distribution is large (possibly with a single large peak or two peaks at around 40 nm and 90 nm), whereas the distribution is much smaller and narrower than that for Triton X on its own. The contact angle of these surfaces can be increased with appropriate surface post-treatment. FIG. 6 shows the surface morphology of a porous silica templated by PMMA and Triton X 100.

When PFOS treatment is applied, the results in TABLE 3 are seen, illustrating the effect of pore size on the contact angle of PFOS-treated polymer templates on a glass substrate.

TABLE 3

| Pore Size | Contact Angle |
|---|---|
| (Angstroms) | (degrees) |
| 50 | 115 |
| {Triton X} | |
| 400-900 | 167 |
| {PMMA & Triton X} | |

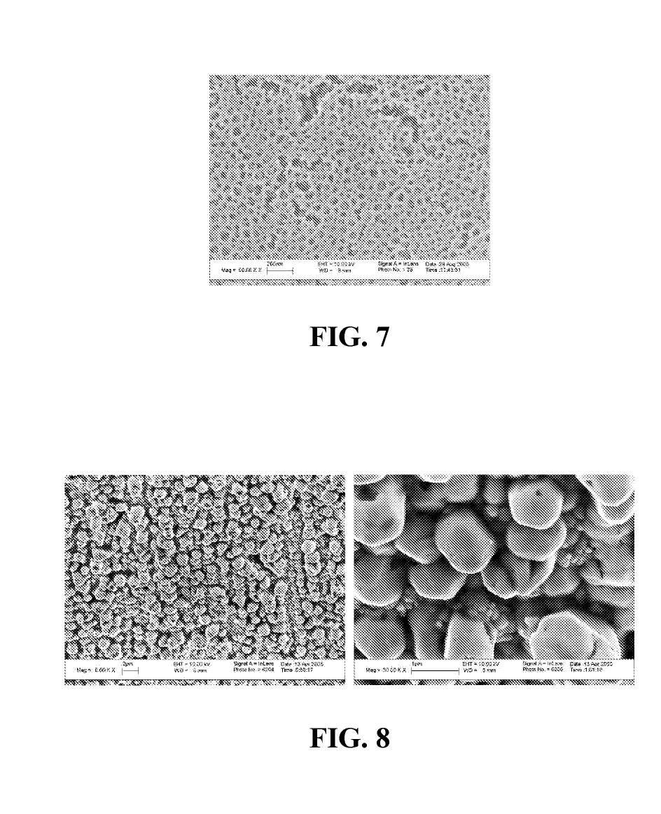

Templating can be run by polymer emulsion suspension, or by individual dipcoating of individual polymer suspensions. In templating by polymer emulsion suspension, the components are combined in a single liquid. A very similar effect can be obtained by avoiding the mixing of the chemical components, and dipcoating the insulator in each component separately. Such an approach would have practical interest as it would preserve the components in a production environment. FIG. 7 shows a surface created by sequential dipcoating in silica sol and PMMA emulsion, although the water repellency of such a coating was not impressive, at 113° even after treatment with PFOS, although it is promising when optimizing the size of the polymer particles.

Templating can also be run by imprinting from rough surfaces. This approach takes a partly cured polymer surface and then impresses a hard surface with a prefabricated rough surface. In one embodiment, the polymer system can be silicone (polydimethyl siloxane), for example, curable SYLGARD 184 (from Dow Corning), which includes a base polymer and curing agent. Before curing, it is liquid so it is relatively easy to process structures of various sizes and shapes. After curing, the silicone becomes solid, and the surface structure can be maintained.

The process description preferably is as follows: after mixing, the base mix (silicone resin/catalyst with curing agent) is spun coated at 4000 rpm to make a thin (10-20 μm) film on a pre-cleaned glass slide. Prior to the spin coating, the glass surface can be treated with ally triethoxysilane (ATES) to ensure good adhesion of the silicone to the slide. The molding rough surface, which is pretreated with PFOS, is then imprinted onto the silicone surface to make a replica rough surface on the silicone film.

The glass slide, silicone, template sandwich is placed in a vacuum at room temperature for two (2) hours. This step can be important to ensure that all of the trapped air is removed from the rough template surface. After the vacuum treatment the silicone is cured at 100° C. for 45 minutes, the template is then peeled off to reveal the imprinted surface. As long as the surface of the template is not damaged during the un bonding, then it may be reused. In preferred embodiments, two templates can be used, for example, commercially available copper foil for FR-4 board, and an etched and oxidized aluminum (to give aluminum oxide) film (AAO).

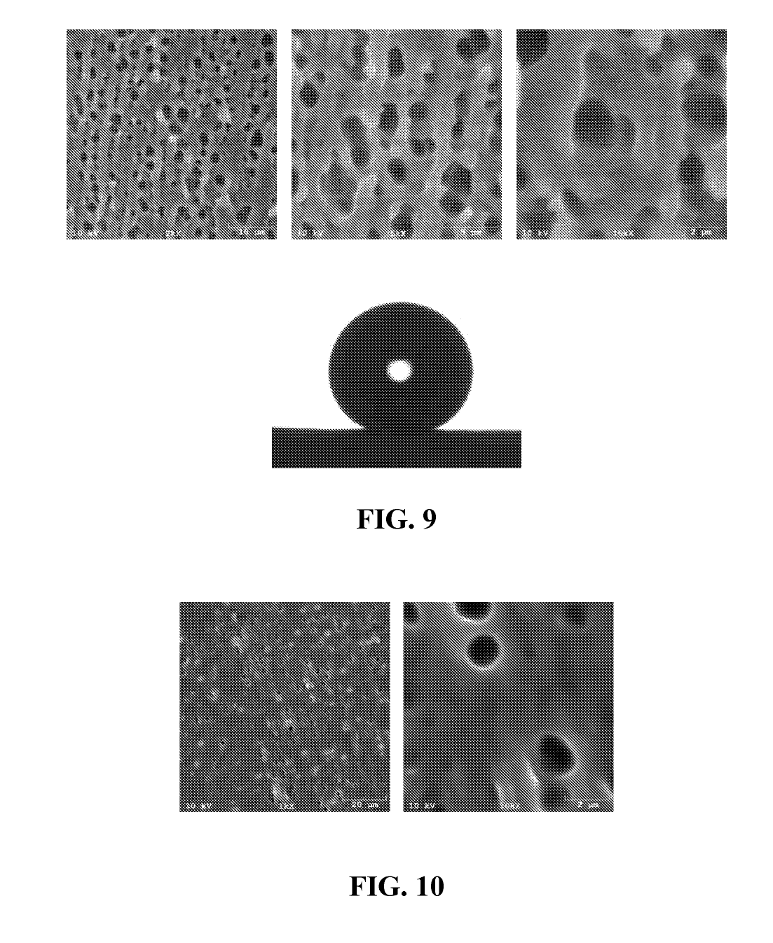

Copper foil with a controlled roughness surface (FIG. 8) is commonly used within the semiconductor industry. This commercially available material was used in tests with all copper foil templating. Templating using the rough copper foil (FIG. 8) gave an imprinted silicone surface that had a contact angle of 158°, and a hysteresis of 8° (FIG. 9). When a vacuum is not used, the contact angle falls to 125° (FIG. 10).

One method for generating rough silicone surface (replica molding) can include using copper foils with rough surfaces as the template for castable/mouldable dielectric materials (epoxy, polyester resins and silicone elastomers (filled and unfilled). The copper surface was first treated with fluoroalkyl silane (PFOS) as a mold release agent. In this case, curable silicone SYLGARD 184, was used as the castable/mouldable material. The SYLGARD was employed with a resin to curing agent ratio of 10:1. Silicone can be applied to the template (copper sheet) by many convenient methods, such as painting, spin coating, dipcoating and molding.

The material is transformed into a thermoset state, and in the case of the silicone elastomer, it was cured at 100° C. under vacuum for between 45 min-2 hrs. Then, the silicone surface was released from the rough copper foil surface and the replicate surface was formed. The surface showed a contact angle of over 150°, and a hysteresis of below 10° (TABLE 4).

In common with many other elastomeric materials, the surface would be expected to benefit from diffusion driven autophobicity—the time dependent post production improvement in hydrophobicity.

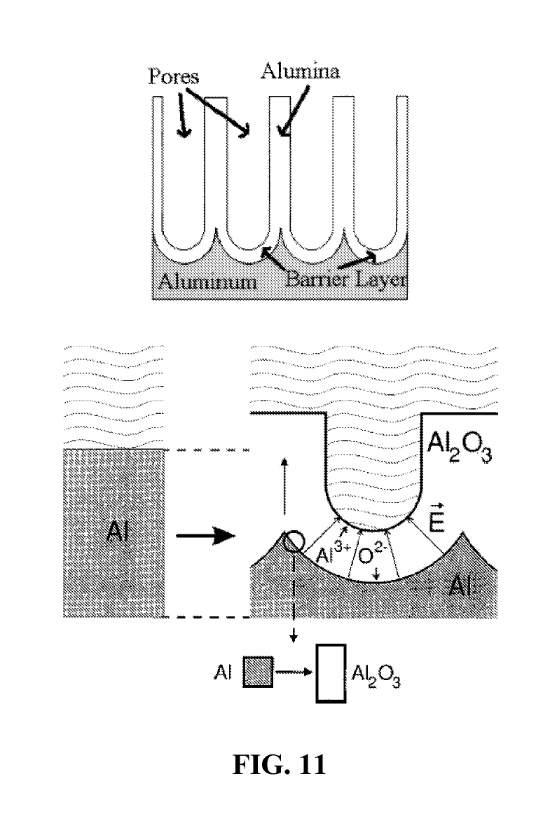

A rough surface can also be created in situ on a mould tool. The most appropriate starting material for the mould is aluminum, which can be readily converted to a porous alumina surface (FIG. 11). This is achieved by the anodic oxidation of aluminum in an acidic electrolyte, such as sulfuric acid or oxalic acid or phosphoric acid. This approach gives a large area, which is self organized at the nanometer-sized structure, and has a high aspect ratio.

Anodic porous alumina has a packed array of columnar hexagonal cells with central, cylindrical, uniformly sized holes ranging from 4 to 200 nm in diameter.

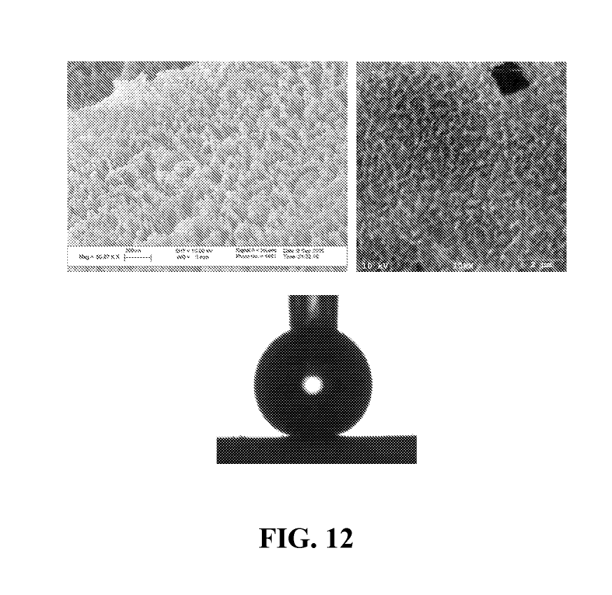

Through the anodic oxidation of aluminum in sulfuric acid, the surface was changed from aluminum to aluminum oxide, and surface roughness was created as shown in FIG. 12. The rough surface on its own might be considered to have some water repellency. However, it does not have the proper surface chemistry. Thus, it is not, of itself, hydroscopic (TABLE 4). In fact, it is hydrophilic. Yet, after the surface was treated with PFOS, the surface contact angle rose to 175.6°, with a hysteresis of around 3.0°.

TABLE 4

| | Rough: | |
|---|---|---|
| | Contact Angle | Rough with Treatment: |
| Surface | (degrees) | Contact Angle (degrees) |
| Cu Template | <5 | Superhydrophobic - 160 to 168 |
| Alumina Template | <5 | Superhydrophobic - 176 |
| Silicone Templated | 158 | — |
| Surface | | |

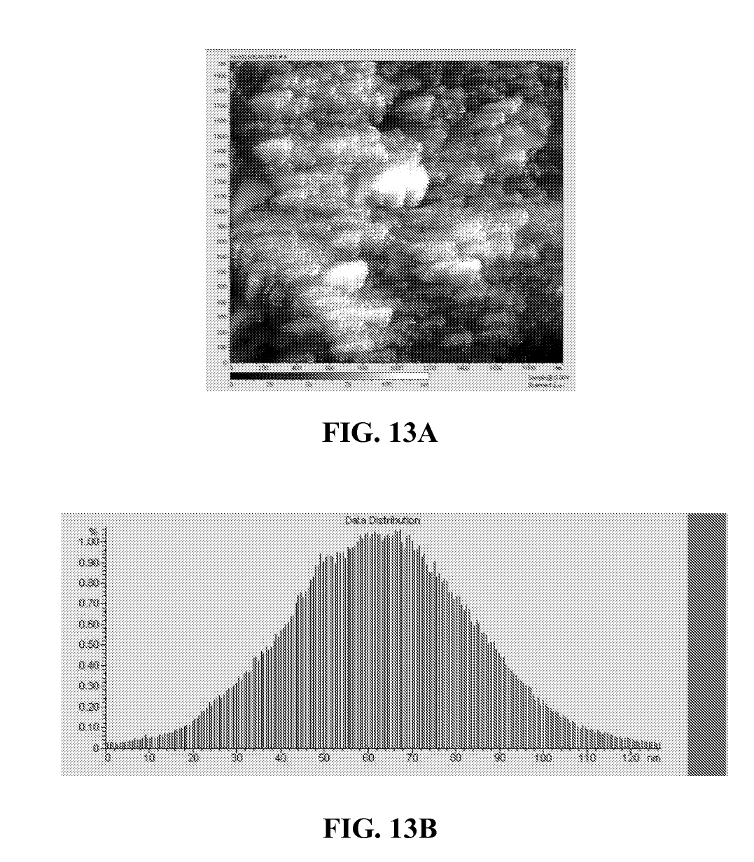

AFM studies (FIG. 13) clearly show the surface roughness of the alumina around 60-70 nm, and this roughness scale is effective in creating superhydrophobicity. However, the QUV stability test showed that after 1000 hours of multi-factor exposure, the contact angle decreased to around 120-130°, and thus the superhydrophobicity was lost.

TABLE 5 shows the multi-factor ageing performance of templated surfaces. An interesting result is that for the alumina surface, the basic structure is likely to be relatively immune to the effects of UV component of the multi-factor exposure. However, the hydrophobicity comes from the PFOS treatment, and thus the fall in performance must be ascribed to the change in surface chemistry, i.e. loss of the hydrophobic groups, rather than the change in the surface itself.

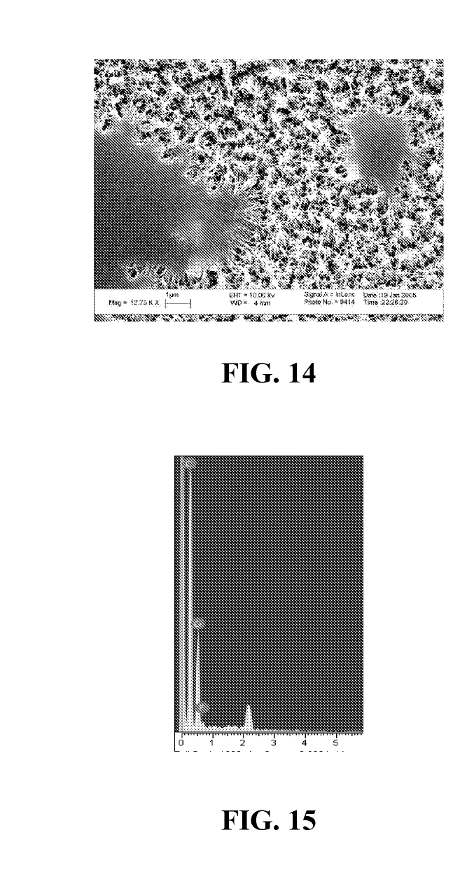

This is an interesting comparison with plasma modified surfaces (FIG. 14), where the surface itself is degraded by the UV. These experiments confirm yet again that the superhydrophobicity is a function of both the structure and the surface chemistry.

TABLE 5

| Multi-factor | Templated Silicone - | |
|---|---|---|
| Ageing | untreated | Alumina Template - |
| Time | Contact Angle | treated with PFOS Contact Angle |
| (hours) | (degrees) | (degrees) |
| 0 | 158 | 176 |
| 1000 | — | 120-130 |

Although the loss of water repellency after 1000 hours precludes this approach from practical use, it is worth while noting that earlier experiments with polymer surfaces had inferior initial properties, and showed a drop to these levels in 100 to 200 hours.

Sol-Gel Technology

In prior experiments, superhydrophobic coatings were developed on polybutadiene surfaces using a SF₆ or CF₄ plasma treatment. However, one of the more serious problems for a polybutadiene surface is that it is very sensitive to UV irradiation.

As can be seen from the SEM image (FIG. 14) and EDX (FIG. 15), after the surface was irradiated under UV light for as little as two (2) days, the surface changed. The change can be seen by the growth of the smooth areas that destroyed the surface roughness. The loss of roughness causes a fall in the contact angle (FIG. 16). Further, the surface chemistry changed as a result of the oxidation of the polymer surface (oxygen content increased to 30% atm.). This effect continued even when UV protection was included. Presumably, this was ineffective as the damage is very highly localized to the surface layers.

The templating experiments with alumina and the polymer template showed that it was possible to create an inorganic surface. Furthermore, these surfaces can be treated to give the correct chemistry. Thus, a method that grew an inorganic coating on the surface of the insulator was pursued. The technology selected for this was the sol-gel process.

The sol-gel process is an established process for making glass/ceramic materials. The sol-gel process involves the transition of a system from a liquid (the colloidal “sol”) into a solid (the “gel”) phase. The sol-gel process allows the fabrication of materials with a large variety of properties: ultra-fine powders, inorganic membranes and thin film coatings.

The sol is made of solid particles of a diameter of few hundred nanometer, usually inorganic metal salts, suspended in a liquid phase. In a typical sol-gel process, the precursor is subjected to a series of hydrolysis and polymerization reactions to form a colloidal suspension, then the particles condense in a new phase, the gel, in which a solid macromolecule is immersed in a solvent.

There are numerous application areas for sol-gel technologies. One of the largest application areas is thin films, which can be produced on a piece of substrate by spin-coating or dip-coating. Other methods include casting, painting, spraying, electrophoresis, inkjet printing or roll coating. Optical coatings, protective and decorative coatings, and electro-optic components can be applied to glass, metal and other types of substrates with these methods.

The sol-gel approach involves the creation of surface roughness (fractal surface) by the evaporation of solvent (ethanol) after the formation of silica gel skeleton (gelation through silanol condensation). The surface hydrophobicity was achieved by the incorporation of the hydrophobic groups. The individual components are termed precursors (e.g. tetraethoxysilane, tetramethoxysilane, isobutyl trimethoxysilane, etc.).

When two or more precursors are combined to make the process more practical, the process is termed a coprecursor process. The second precursor contains the hydrophobic hydrocarbon/fluorocarbon group, e.g., TMOS-IBTMOS, TFPS-TEOS, etc., and at least one of the precursors contributes hydrophobic groups, such as isopropyl, trifluoropropyl groups, etc.

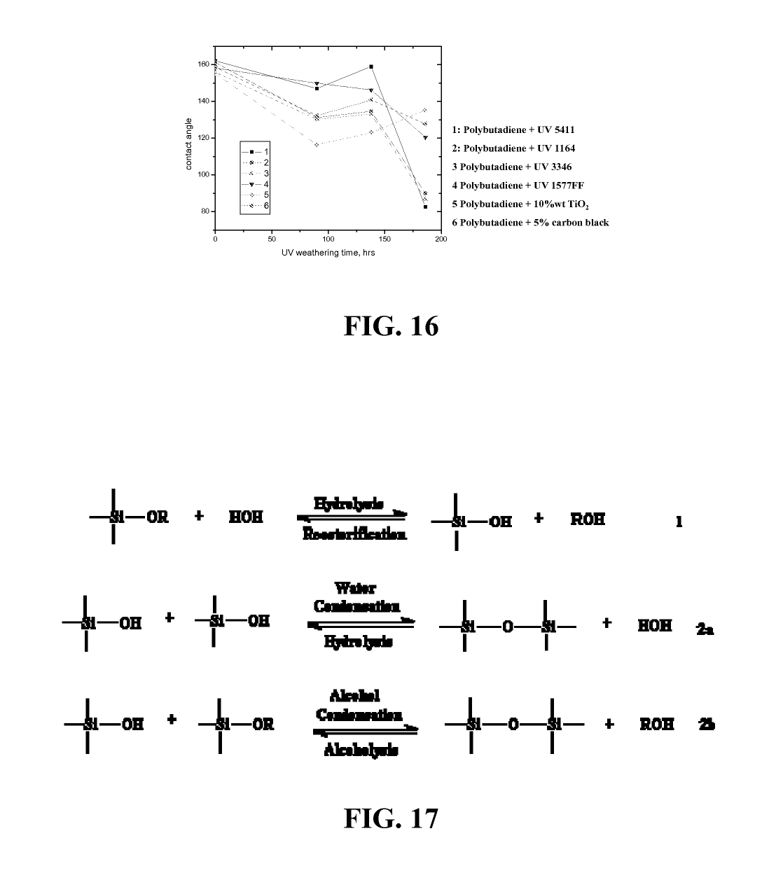

FIG. 17 shows a generalized reaction mechanism for precursors. TABLE 6 shows five examples of the components and formulations for sol-gel materials.

TABLE 6

| Material Example I | Material Example II | Material Example III | Material Example IV | |
|---|---|---|---|---|
| IBTMOS & TMOS | TFPS & TEOS | Eutectic | Eutectic | Material Example V |
| coprecursor | coprecursor | precursor | precursor | precursor |
| TMOS (50-200 g) | TEOS (50-200 g) | TEOS (10.5-35.3 g) | TPT (39.0 g) | TEOS (2-20 g) |
| IBTMOS (50-200 g) | TFPS (50-200 g) | — | — | — |
| — | — | Eutectic Liquid (2:1 | Eutectic Liquid (2:1 | — |
| | | mixture of Choline | mixture of Choline | |
| | | Chloride and Urea) | Chloride and Urea) | |
| | | (58.8-87.7 g) | (58.5-90 g) | |
| Ethanol (400 g) | Ethanol (125 100-400 g) | Ethanol (0-400 g) | Ethanol (0-400) | Ethanol (20-400 g) |
| Deionized Water | Deionized Water | — | Deionized Water | Deionized Water |
| (100 g) | (100 g) | | (2.5 g) | (0-10 g) |
| Hydrochloric Acid | Hydrochloric Acid | Diluted Hydrochloric | — | — |
| 1M (10 g) | 1M (2 g) | Acid 1M (1.8-5.9 g) | | |
| Ammonim hydroxide, | Ammonim hydroxide | Ammonim hydroxide | — | Ammonim hydroxide |
| 1.1M (100 ml) | (25%) (10 ml) | (25%) (10 ml) | | 25% |
| | | | | (10-100 ml) |

### Method Example I

TMOS (Precursor), IBTMOS (Coprecursor), and ethanol are first mixed together using the amounts given in TABLE 6 under “Material Example I.” HCl (0.1 M) is added to adjust the pH of the mixture to around 1.8-2.0. The reaction is started by heating to 60° C., and then holding for five (5) hours. After the reaction NH₃H₂O, 1.1M, a base, was added to the solution to initiate gelation of the polymer.

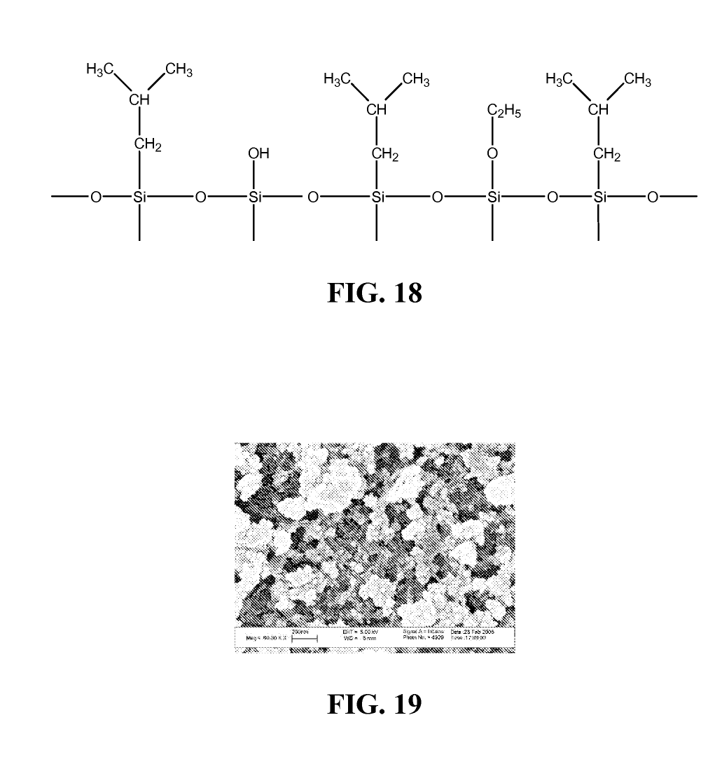

Before complete gelation, the solution may be cast onto a suitable substrate (microscope glass slide, elastomer, etc) to form a thin layer. The surface was covered to ensure slow evaporation of the ethanol and ammonia. After two (2) days, the film was completely gelled and the ethanol was completely evaporated. A thin silica layer was left on the substrate surface. Implementation on a glass microscope slide showed that the surface was superhydrophobic directly after coating due to the hydrophobic side chains present in IBTMOS coprecursor (FIGS. 18-19). TABLES 7-8 display alternate formulation approaches to that disclosed in TABLE 6 under “Material Example I.”

Physical characteristics of solutions resulting from different sol formulation:

TABLE 7

| | | Transparency | Precipitation | Contact Angle |
|---|---|---|---|---|
| TMOS:IBTMOS | Phase Separation | During | After | Of The Surface |
| (Volume Ratio) | During Hydrolysis | Gelation | Gelation | (degrees) |
| 3:1 | No | Yes | No | 65-75 |
| 2:2 | No | No | No | 155-160 |
| 1:3 | Yes | No | Yes | 75 |

Contact angle of films resulting from various formulations of bulk silica layers:

TABLE 8

| | | | | | | NH₄OH | Contact |
|---|---|---|---|---|---|---|---|
| | TMOS | IBTMOS | Ethanol | | 1M HCl | 1.1 M | Angle |
| Sample | (ml) | (ml) | (ml) | H₂O (ml) | (ml) | (ml) | (degrees) |
| 1-1 | 1 | 3 | 4 | 1 | 0.03 | 1 | 128.0 |
| 1-2 | 1 | 3 | 4 | 2 | 0.03 | 0.5 | 160.8 |
| 1-3 | 1 | 3 | 4 | 2 | 0.08 | 1 | 157.5 |
| 1-4 | 1 | 3 | 4 | 2 | 0.03 | 1 | 105.0 |
| 2-1 | 2 | 2 | 4 | 2 | 0.03 | 1 | 121.0 |
| 2-2 | 2 | 2 | 4 | 0.9 | 0.1 (0.1392M) | 1 | 143.2 |
| 2-3 | 2 | 2 | 4 | 1.9 | 0.1 (0.1392M) | 1 | 156.1 |
| 3-1 | 3 | 1 | 4 | 2 | 0.03 | 1 | 75.0 |

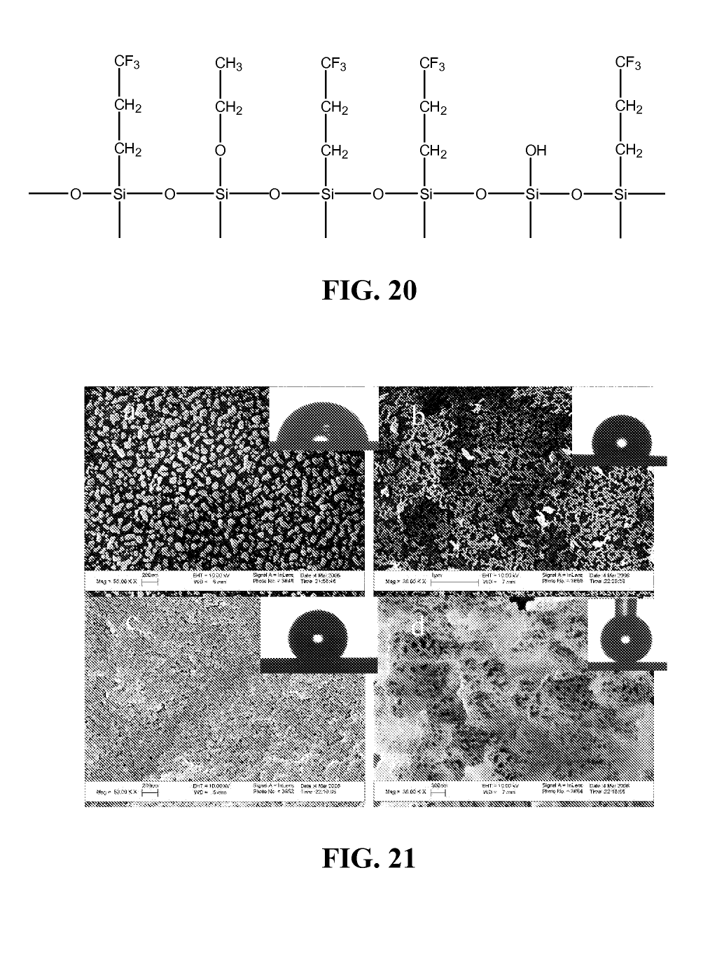

Although superhydrophobic surfaces may be attained (TABLES 7-8) using the correct formulations, the multi-factor ageing resistance of the IBTMOS version is only sufficient for indoor or protected environments. This limitation is most probably due to the existence of the tertiary carbon on the isopropyl chain. After the multi-factor ageing (QUV) test for 1000 hours, the superhydrophobicity was found to be lost (contact angle<<150° and hysteresis>>10°) and the water droplet was completely dispersed over the surface. The multi-factor ageing (QUV) performance was improved by the incorporation of a stable chain into the chain backbone. FIG. 20 shows the improvement from the copolymerization of TFPS-TEOS.

### Method Example II

TEOS (Precursor), TFPS (Coprecursor), and ethanol are first mixed together using the amounts given in TABLE 6 under “Material Example II.” HCl (1 M) is added to adjust the pH to around 1.8-2.0. The reaction was started by heating to 60° C., where the temperature was maintained for five (5) hours. After the reaction, 0.1 g ammonia hydroxide (29% wt) was added (1.1 M) to 2 g solution for gelation of the polymer.

Before complete gelation, the solution was cast onto a suitable substrate to form a thin layer. The surface was covered to ensure slow evaporation of the ethanol and ammonia. After two (2) days, the film was gelled and the ethanol was evaporated. A thin silica layer was left on the substrate, of which a suitable illustrative example is a glass microscope slide.

The surface is superhydrophobic due to the hydrophobic side chains present in TFPS coprecursor (FIGS. 20-21). FIG. 21 includes SEM micrographs of the TFPS-TEOS surfaces for different reagent ratios (FIG. 21A 1:3, FIG. 21B 1:1, FIG. 21C 2:1, and FIG. 21D 3:1 respectively). The drop shapes show the effects of the different untreated sol-gel surfaces.

TABLE 9

TFPS:TEOS

| | 1:3 | 1:1 | 2:1 | 3:1 |
|---|---|---|---|---|
| Contact Angle | 82.3 | 118.0 | 136.5 | 172.0 |
| (degrees) | | | | |
| Hysteresis | — | — | — | <5 |

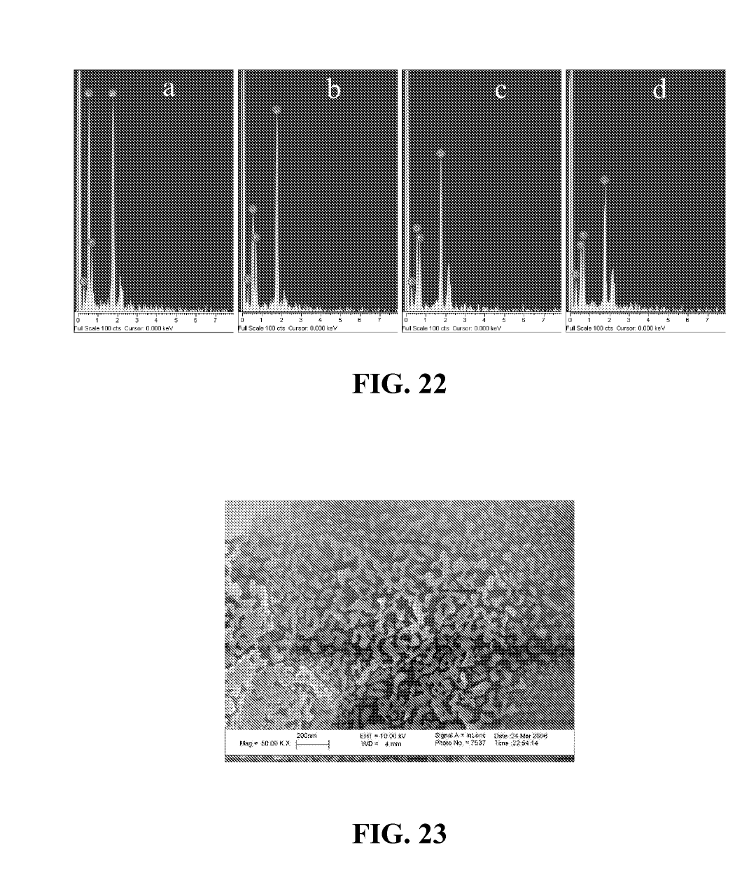

FIG. 22 is an EDX analysis of the surface elements for the same surfaces shown in FIG. 21. With the increase of the ratio of TFPS:TEOS, the fluorine content increases, and this results in the decrease of the surface energy of the synthesized silica.

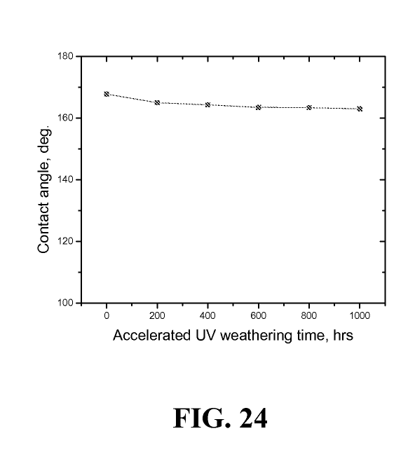

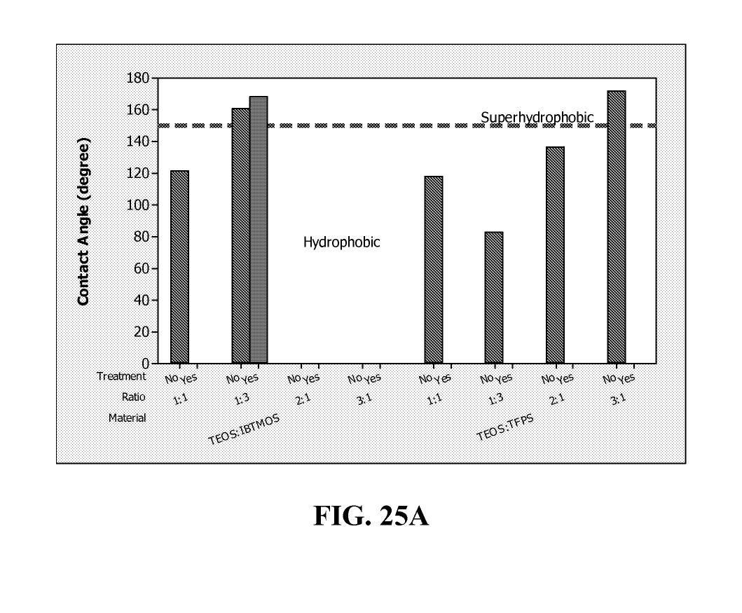

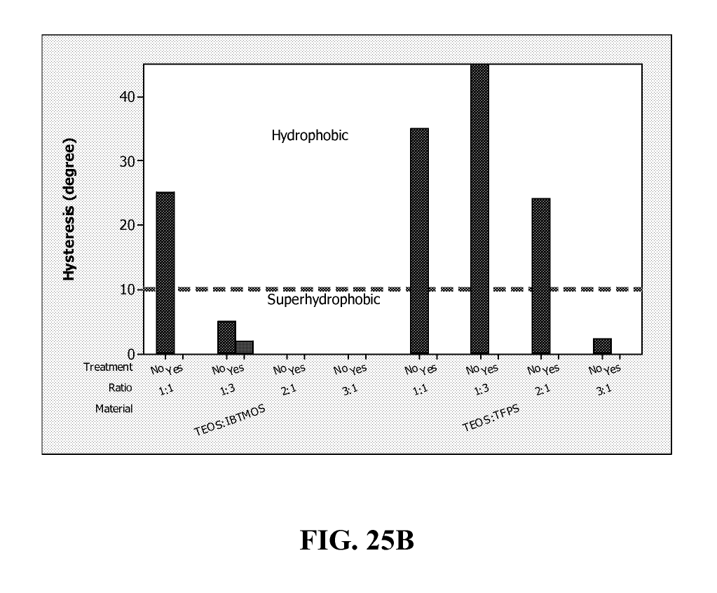

FIG. 23 is a surface nanostructure, by SEM, of TFPS:TEOS=3:1 film. Analysis of the surface chemistry undertaken with EDS analysis, shows the atomic concentration of fluorine is 42.0% for TFPS:TEOS=3:1, much higher than the theoretical value of 31.6%. This shows that fluorine is concentrated on the surface, in the surface nanoparticles. FIG. 24 is the multi-factor ageing (QUV) stability test of the surface shown in FIG. 23 with a glass substrate. FIG. 25 shows the initial contact angle and hysteresis for the structures shown in FIGS. 19 and 21.

### Method Example III

Initially, a eutectic liquid was formed by mixing choline chloride and urea together in a ratio of 2:1

A formulation is described in TABLE 6 under “Material Example III.” Tetraethoxysilane (TEOS—Precursor): 0.6 g, eutectic mixture (C—U): 1-6 g, ethanol: 1.5-3 g, 1M HCl aqueous solution: 0.3 g are all mixed together. Hydrolysis and condensation occurs after the addition of HCl to the mixture, and stirring for three (3) hours. The solution was coated onto a s suitable substrate. In this example the solution was then spin coated onto one (1) square inch glass microscope slides at 3000-6000 rpm to form uniform films. The coated glass slide was placed in a desiccator with a container of 1 ml ammonia (29%) at the bottom, to promote gelation. After two (2) days, the glass slide was removed from the desiccator and extracted with absolute ethanol for three (3) hours to remove the eutectic liquid in the film, and thus yield a porous thin film. The transmittance of the film coated glass slide from UV-Visible is comparable to the transmittance of glass slides or better than that of glass slides. The contact angle was 171.0° and hysteresis was <4°.

### Method Example IV

Initially, a eutectic liquid was formed by mixing choline chloride and urea together in a ratio of 2:1. An alternate method mixes the appropriate amounts of choline chloride and urea with the main formulation components.

Another formulation for the eutectic method (not disclosed in TABLE 6) was: tetromethoxysilane (TMOS—Precursor): 0.5 g, choline chloride-urea (C—U): 3 g, 1M HCl aqueous solution: 0.3 g. Hydrolysis and condensation occurs after the addition of HCl to the mixture, and stirring for three (3) hours. The solution was then spincoated onto one (1) square inch glass microscope slides at 3000-6000 rpm to form uniform films. The coated glass slide was placed in a desiccator with a container of 1 ml ammonia (29%) at the bottom, to promote gelation. After two (2) days, the glass slide was removed from the desiccator and extracted with absolute ethanol for three (3) hours to remove the eutectic liquid in the film, and thus yield a porous thin film. The transmittance of the film coated glass slide from UV-Visible is comparable to the transmittance of glass slides or better than that of glass slides. The contact angle was 170.8° and hysteresis was <4′. Similar hydrophobicity improvements would result for alternate substrates such as elastomers, plastics and resins.

### Method Example V

Tyzor TPT (Precursor) was used for the reaction described in TABLE 6 under “Material Example IV.” Initially, the eutectic liquid (C—U) is mixed with an ethanol/water mixture (2.5 ml of water in 58.5 ml C—U with between 0.5 to 2.5 ml of ethanol), then TPT is slowly added TPT, after the final addition of the TPT, the mixture is continually stirred for two (2) hours. This will result in a solution that is suitable for the desired application process. The solution can be coated on both ceramic surfaces and polymeric surfaces. The surfaces may be either treated as received or after surface treatment by plasma or UV/ozone.

After the coating was made, it was then exposed to an ammonia atmosphere for four (4)-48 hours. Afterwards, the surface was rinsed with ethanol to remove the eutectic liquid, and a rough surface resulted. Then, the surface can be treated hydrophobic by plasma deposition, SAM treatment or other surface treatment methods that may make the surface hydrophobic. After the surface was treated, the contact angle on the surface was over 145°.

Multi-Modal Size Distributions

The Lotus leaf has a very complicated surface that is rough on the microscopic and nanometric scale. The manufacture of a multi-modal (in size) surface using the sol-gel process was investigated.

Synthesis of monodisperse silica spheres is accomplished using the Stöber-Fink-Bohn method that involves using base (ammonia) as catalyst. The production of a uni-modal distribution is first described.

TEOS at 60° C. undergoes hydrolysis to form silanol groups that are further catalyzed under ammonia to undergo condensation between each other to form siloxane polymers (branched or linear depending on the reaction conditions) dissolved in solvent. When the polymer particles are large enough, it can form aggregates which are separated from the solvent by the negative surface charges.

At the beginning, the surface charge is not large enough to repel the aggregates, so the aggregates undergo particle growth to form larger ones by the Ostwald ripening process with smaller particles dissolving and redepositing on large particles until uniform size was achieved. When more TEOS is added, the particle can further grow to form a larger one, with the reaction between newly added hydrolyzed TEOS and the silica sphere surface silanol groups (seed growth). The particle size was controlled by catalyst (pH), water concentration and TEOS concentration.

Multi-modal size distributions are achieved by growing two or more uni-modal distributions separately and then mixing them together. After the coating process (dipcoating or painting) on the desired surface, surface roughness can be created.

Controlling the amount of ammonia hydroxide, water, TEOS, and the reaction temperature, the particle size of silica can be controlled. Equation 8 gives the average diameter (d) in terms of the concentrations (mol/l) of water (H₂O), Ammonia (NH₃) and TEOS in room temperature, and thereby shows how the size distributions might be controlled.

d=((82−151NH3+1200NH3²−366NH3³)\sqrt{TEOS})H2O²exp((0.128NH3²−0.523NH3²−1.05)\sqrt{H2O}) Equation 8

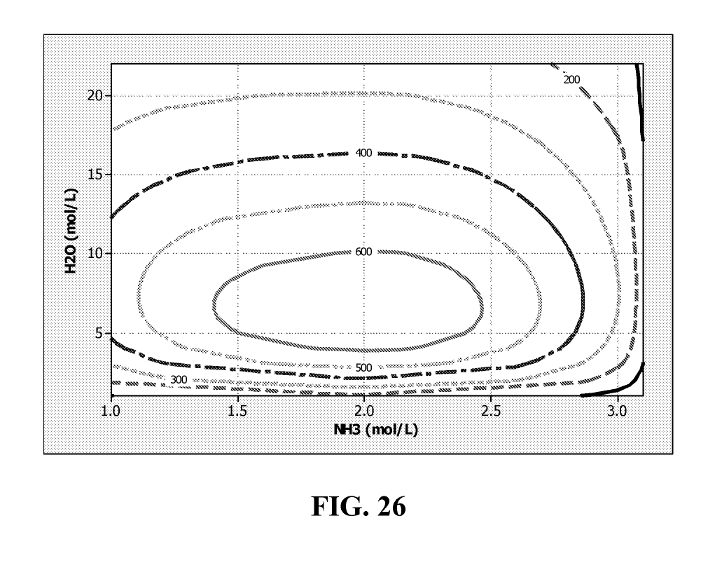

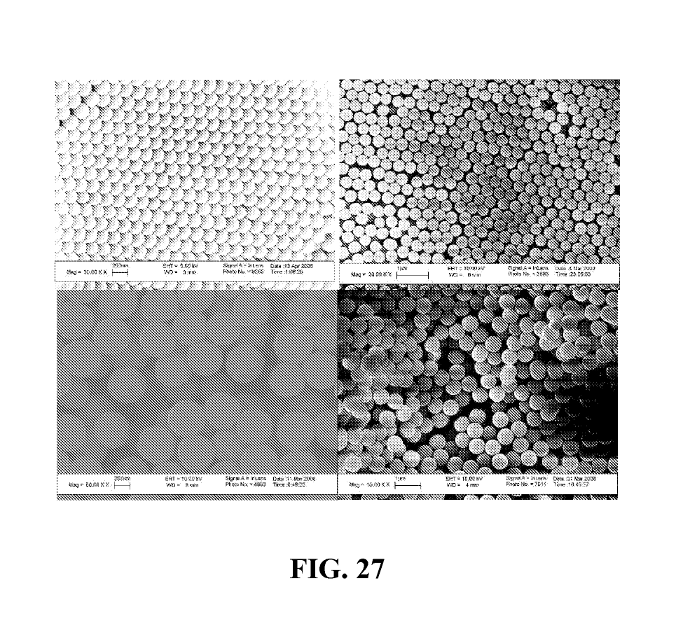

FIG. 26 shows contours of the final particle diameters (nanometers) as obtained by reacting 0.3 mole/liter of tetraethyl silicate with various concentrations of water and ammonia in ethanol following Equation 8. FIG. 27 shows the monodisperse silica spheres produced using different conditions (primarily acidity); FIG. 27A 200 nm, FIG. 27B 300 nm, FIG. 27C 370 nm, and FIG. 27D 600 nm, by varying the ammonia content and TEOS concentration in the reaction.

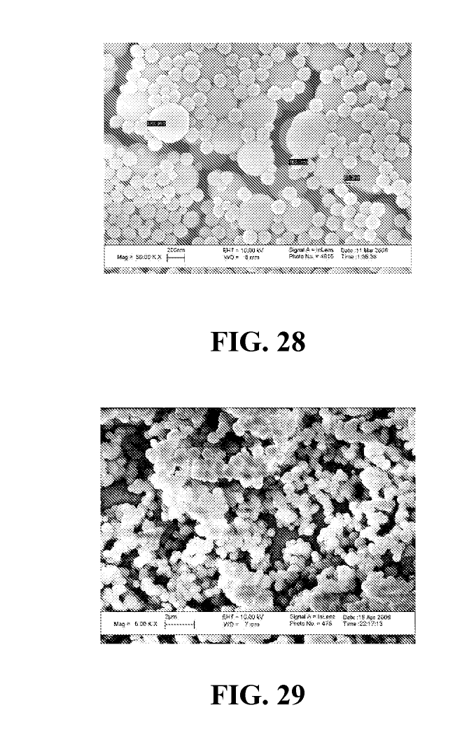

The surface structure (morphology and surface roughness), has been analyzed mainly using scanning electron microscopy (SEM). FIG. 28 shows multi-modal (bi-modal) sized distribution of silica particles grown on an insulating surface (silicone rubber)—mean large 470 nm, mean small 150 nm. (dipcoating sequentially in two ethanol dispersions (first, 470 nm dispersion, second, 150 nm dispersion)); contact angle: 140° after PFOS treatment.

When using tri-modal or more particle sizes, the silica spheres will not form a densely arrayed structure on the surface. As can be seen in the figures, the surfaces are rougher than the densely packed ones. And as a result, the surface contact angle was higher (superhydrophobicity was achieved) than the uni-modal distribution particles.

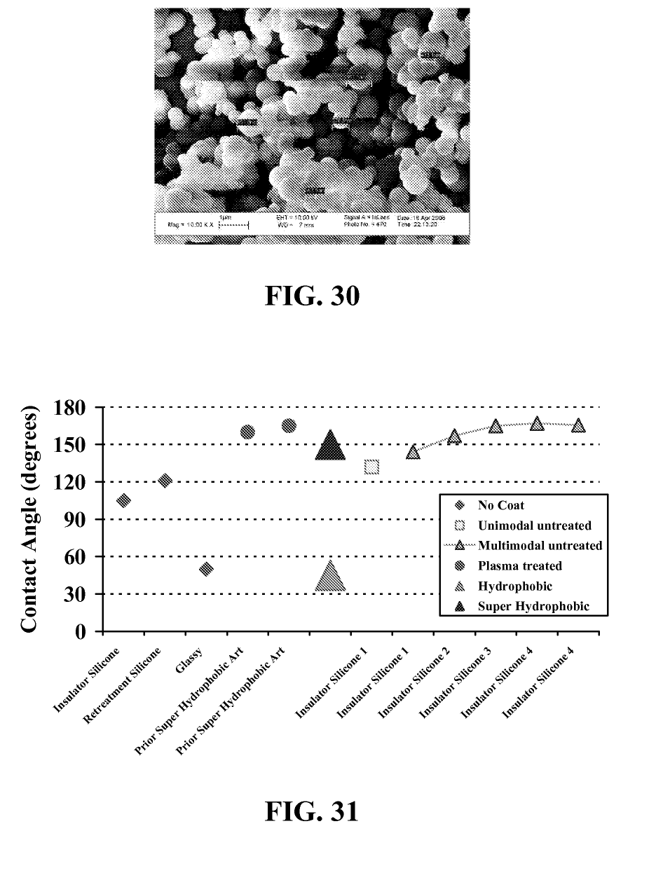

FIG. 29 shows multi-modal (tri-modal) sized distribution of silica particles grown on an insulating surface (silicone rubber): mixture of 350 nm, 550 nm, and 850 nm particles. FIG. 30 shows multi-modal (quadra-modal) sized distribution of silica particles grown on an insulating surface (silicone rubber): mixture of 350 nm, 450 nm, 550 nm, and 850 nm particles.

TABLE 10 shows a range of potential size ratios:

TABLE 10

| | Examples | | | | | | | | | |
|---|---|---|---|---|---|---|---|---|---|---|
| | 1 | 2 | 3 | 4 | 5 | 6 | 7 | 8 | 9 | 10 |
| Mean Particle Size - | 0.85 | 0.47 | 0.2 | 0.6 | 0.35 | 0.8 | 0.47 | 0.6 | 0.6 | 0.8 |
| largest fraction | | | | | | | | | | |
| (μm) | | | | | | | | | | |
| Mean Particle Size - | 350 | 150 | 50 | 100 | 50 | 100 | 50 | 50 | 15 | 15 |
| smallest fraction | | | | | | | | | | |
| (nm) | | | | | | | | | | |
| Ratio Mean | 2.4 | 3.1 | 4 | 6 | 7 | 8 | 9.4 | 12 | 40 | 53.3 |
| Largest/Mean | | | | | | | | | | |
| Smallest | | | | | | | | | | |

| | |
|---|---|
| Ratio of Standard | 0.2-5 |
| Deviation | |
| Largest/Standard | |
| Deviation Smallest | |

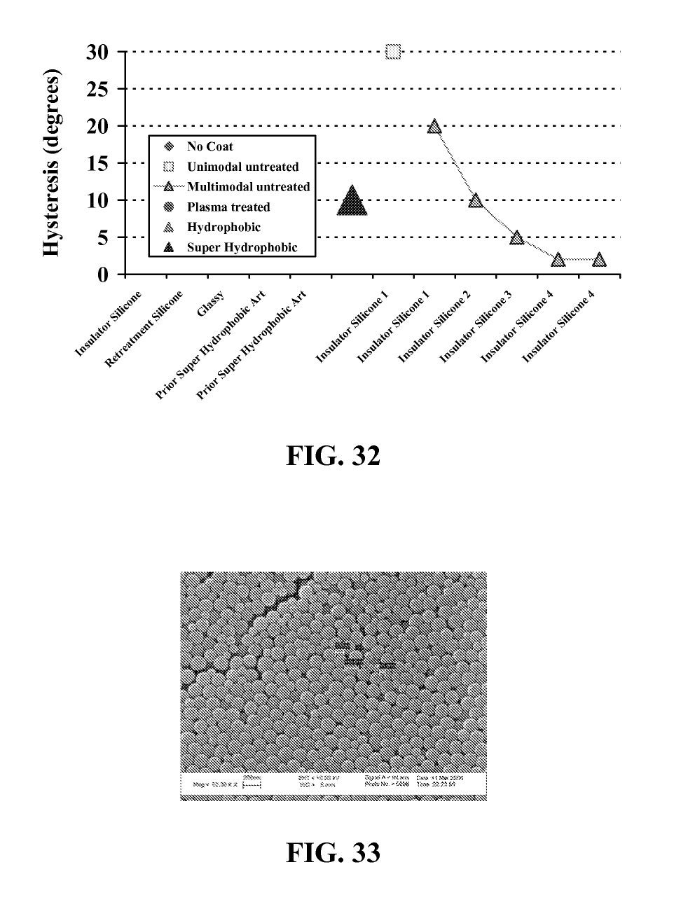

The general results for the multi-modal approach can be summarized as shown in FIGS. 31 and 32.

### Method Example VI

The different size distributions are determined by control of the process conditions. The below variants (a), (b), (c) and (d) disclose the basic approaches using precursor sol gels.

(a) Following TABLE 6 under “Material Example V,” mix TEOS 6 ml, ammonia hydroxide (25% V/V) 15 ml, and absolute ethanol 200 ml at 60° C. and keep stirring for five (5) hours. A silica colloid resulted with a diameter of 80 nm with a polydispersity of 16%.

(b) Following TABLE 6 under “Material Example V,” mix TEOS 3.5 ml, ammonia hydroxide (25% V/V) 4 ml, and absolute ethanol 50 ml at 60° C. and keep stirring for five (5) hours. A silica colloid resulted with a diameter of 300 nm with a polydispersity of 10%.

(c) Following TABLE 6 under “Material Example V,” it is possible to use a seeded growth approach. Use the procedure (a) to prepare the seed solution. Then TEOS and H₂O (7 ml/1.2 ml) are repeatedly added to the seed suspension after the seed suspension has stopped reacting at a five (5) hour interval. The final particle sizes after ten (10) additions was 197 nm. By changing the initial reaction condition and the repeat condition, a series of silica particles was prepared as shown in TABLE 10.

(d) Following TABLE 6 under “Material Example V,” mix TEOS 6 ml, ammonia hydroxide (25% V/V) 15 ml, and absolute ethanol 200 ml at room temperature and keep stirring, at the same time increase the temperature from room temperature to 60° C. in 45 min, then keep stirring for four (4) hours. A silica colloid resulted with polydispersity that was shown in the following SEM image in FIG. 33.

Preparation of Multimodal Colloidal Silica and Coating on Silicone Surfaces: Mix Two or more silica colloidal particles prepared using steps (a), (b), (c) and (d) above in the appropriate mixtures to deliver the appropriate different particle sizes. The resultant materials may then be dipcoated onto a suitable substrate; in this example, a silicone surface (cured SYLGARD 184 film) was chosen to be treated with the colloidal mixtures.

After some time (3-4 hours), the contact angle of the surface will change from superhydrophilicity (below 10°) to superhydrophobicity (>150°). This shows the autophobicity of the surface, which implies the self-recovery of the surface hydrophobicity at some circumstances was lost. This was confirmed by the multi-factor (QUV) aging test. The surface may show improved results if the silicone surface was pretreated by O₂ plasma, UV/Ozone or some appropriate methods.

Multimodal surfaces can be prepared from mixing the appropriate amounts of the different variants detailed above ((a), (b), (c) and (d)). A selection of practical preparation details are provided below (1-iv):

(i) Dipcoat a glass slide with a colloidal silica mixture of 850 nm and 350 nm. After the solvent was dried, the contact angle was measured, and water droplets spread on the surface indicating hydrophilic (low contact angle performance). Then, the as-coated surface was post-treated with PFOS. This post-treatment resulted in a contact angle of 167.0° and a hysteresis of 4.5°, which showed a superhydrophobic surface.

(ii) Dipcoat a silicone surface with a colloidal silica mixture of 850 nm and 350 nm particle sizes. Immediately after the solvent removal, contact angle measurements demonstrated that water droplets spread on the surface indicating hydrophilic behavior (low contact angle performance). After four (4) hours at ambient conditions with no subsequent post-treatment, a contact angle of 165.6° and hysteresis of 4.7° was achieved, which indicated a superhydrophobic surface. The generation of hydrophobicity after production of the surface herein is termed “autophobicity”. Environmental ageing (multi and single factor) on these silicone substrate surfaces showed that the contact angles directly after removal are in the ranges of 158° to 170° (after 1000 hours), and 160° to 170° (after 2000 hours). Multi-factor (condensation, temperature, UV) ageing shows a higher degradation at 1000 hours (contact angle directly after removal of between 158° to 162°), whereas single (temperature) ageing shows lower degradation (contact angle directly after removal of between 165° to 170°). These silicone surface examples display the commonly observed recovery of hydrophobicity with time, wherein after multi-factor ageing for 1000 hours, the hysteresis falls from 12° to 8° after six (6) days of ambient recovery.

(iii) Dipcoat an EPDM (known to contain diffusible/mobile species such as low molecular weight species, oil, waxes, etc.) surface with a colloidal silica mixture of 850 nm and 350 nm. Immediately after the solvent removal, the contact angle was measured, and water droplets spread on the surface indicating hydrophilic behavior (low contact angle performance). After four (4) hours at ambient conditions with no subsequent post-treatment, a contact angle of >150° and hysteresis of <10° was achieved, which indicated a superhydrophobic surface. The hydrophobicity can be further enhanced through the use of the post-treatment approach disclosed in step (i) above.

(iv) Dipcoat an EPDM (without diffusible/mobile species) surface with the as prepared colloidal. After the solvent removal, the contact angle was measured and water droplets spread on the surface indicating hydrophilic behavior (low contact angle performance). In this situation, no improvement in hydrophobicity occurred with time. It is believed that the absence of autophobicity may be explained by the absence of diffusible or mobile species within the substrate matrix. Furthermore, it is likely that the surface will achieve superhydrophobicity using the post-treatment approach disclosed in step (i) above.

### Method Example VII

In some instances it is advantageous to functionalize the surface in situ during the coating manufacture. One advantage of such functionalization is that it promotes the interparticle adhesion. The preparation procedures for surface functionalized nanoparticles are shown below:

(i) Mix TEOS 6 ml, ammonia hydroxide (25% V/V) 15 ml, and absolute ethanol 200 ml at 60° C. and keep stirring for five (5) hours. To the reaction solution add a mixture of the aminopropyltriethoxysilane (APS) APS/ethanol (0.2 ml/10 ml) solution, then stir for 12 hours at 60° C. under an N₂ atmosphere. The silica surface functionalized with amino groups is prepared directly when applied to the substrate. The autophobicity and post-treatment processes previously disclosed may not be essential to achieve improved hydrophobicity, but can serve to improve performance of the surface.

(ii) Mix TEOS 3.5 ml, ammonia hydroxide (25% V/V) 4 ml, and absolute ethanol 50 ml at 60° C. and stir for five (5) hours. A silica colloid resulted with a diameter of 300 nm and a polydispersity of 10%. The silica particles were centrifuged from the ethanol, and then subsequently washed with ethanol. The process was repeated, in this example four (4) times proved to be sufficient, and then the colloid was redispersed in toluene. The silica/toluene mix was then dissolved in a solution of glycidoxy propyl trimethoxysilane (GPS)/toluene (0.1 ml/5 ml), at room temperature, and continuously stirred for 24 hours under N₂ atmosphere. The resulting particle surface was then functionalized with epoxy groups. The autophobicity and post-treatment processes previously disclosed may not be essential to achieve improved hydrophobicity but can serve to improve performance of the surface.

(iii) Mix TEOS 3.5 ml, ammonia hydroxide (25% V/V) 4 ml, and absolute ethanol 50 ml at 60° C. the mixture is kept stirring for five (5) hours. A silica colloid resulted with a diameter of 300 nm with a polydispersity of 10%. The reaction mixture was then added to a solution of allyl trimethoxysilane/ethanol (0.3 ml/10 ml). This was then stirred for 12 hours at 60° C. under N₂ atmosphere. The silica surface was then functionalized with vinyl groups. The autophobicity and post-treatment processes previously disclosed may not be essential to achieve improved hydrophobicity, but can serve to improve performance of the surface.

The surface functionalized silica (amino-, epoxy-, vinyl-; steps i to iii above) can be applied in many variations to functionalize silicone films (epoxy-PDMS, amino-PDMS, silyl-PDMS). The resulting surface adhesion is markedly improved.

Porous Silica Particles For Silicone Superhydrophobic Coating

Autophobicity, post-treatment and recovery after multi-factor ageing are all important elements of a superhydrophobic surface and the attendant substrate. Thus, if the particulate surfaces resulting from the synthesis of inorganic surfaces can be engineered to maximize these features, hydrophobicity will be improved. One convenient method is to synthesize a porous structure for the inorganic particles. It is believed that such a structure will aid autophobicity, post-treatment and recovery after multi-factor ageing through the provision of reservoirs close to the surface.

It has been found convenient to use the Stöber method for the synthesis of silica particles. After adding templating agents like Pluronic series surfactant (e.g. P123), or Triton X 100, porous silica nanoparticles will be generated. The application of the particles on silicone surface by a method describe above produces a surface that will automatically convert to a superhydrophobic surface (contact angle over 150° and hysteresis below 10°), and maintain the superhydrophobicity for prolonged time (over 1000 hours).

### Method Example VIII

Mix TEOS 3 ml, ammonium hydroxide 7.5 ml, absolute ethanol 100 ml and Pluronic P123 3 g at 55° C. and keep stirring for five (5) hours. A mesoporous silica nanoparticles colloid will result. The particles are then centrifuged out of the ethanol, and are then washed with absolute ethanol. The centrifuge and wash procedure is repeated, preferably 4-5 times, which was often sufficient. The particles are redispersed in absolute ethanol for application (dipcoating) on silicone rubber surfaces. The surface showed change from superhydrophilicity to superhydrophobicity after 3-6 hours—the autophobicity effect. Other surfactants, such as Triton X 100 and cetyl trimethyl ammonium bromide can also be used to prepare the mesoporous silica particles. The trimethyl benzene can be used to control the pore size.

Multi-Species

In order to achieve better adhesion between the coating and the substrate, better self-cleaning, and also incorporate more functionality into the surface coating, a second species was added to the conventional uni-species applications. Experiments were mainly focused on TiO₂ by the sol-gel process to form TiO₂ (core)/SiO₂ (shell) or SiO₂ (core)/TiO₂ (shell) particles.

Monodisperse spherical TiO₂ particles were first prepared by controlled hydrolysis of titanium tetraisopropoxide in ethanol. An ethanol volume of 100 ml was mixed with 0.4-0.6 ml of aqueous salt (NaCl), followed by addition of 2.0 ml of titanium tetraisopropyloxide at ambient temperature under inert gas atmosphere, using a magnetic stirrer. Reagents had to be mixed completely so that nucleation would occur uniformly throughout the solution. Depending on the concentration, visible particle formation started after several seconds or minutes, and gave a uniform suspension of TiO₂ beads. After five (5) hours the reactions were finished, and the spheres were collected on a Millipore filter and washed with ethanol.

In one embodiment, this above process is amended for multi-modal particles by:

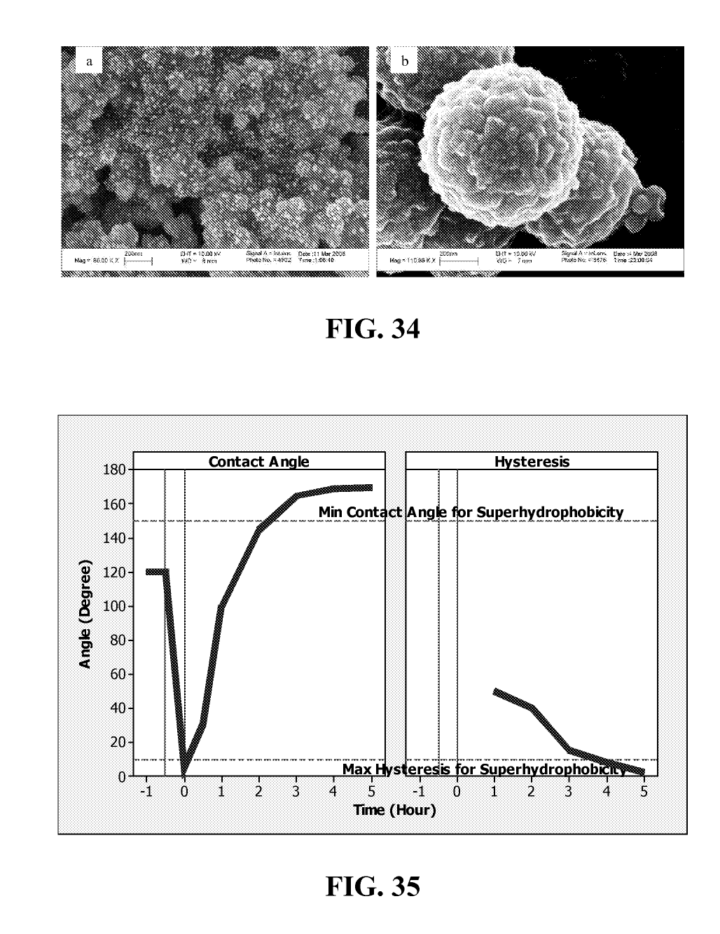

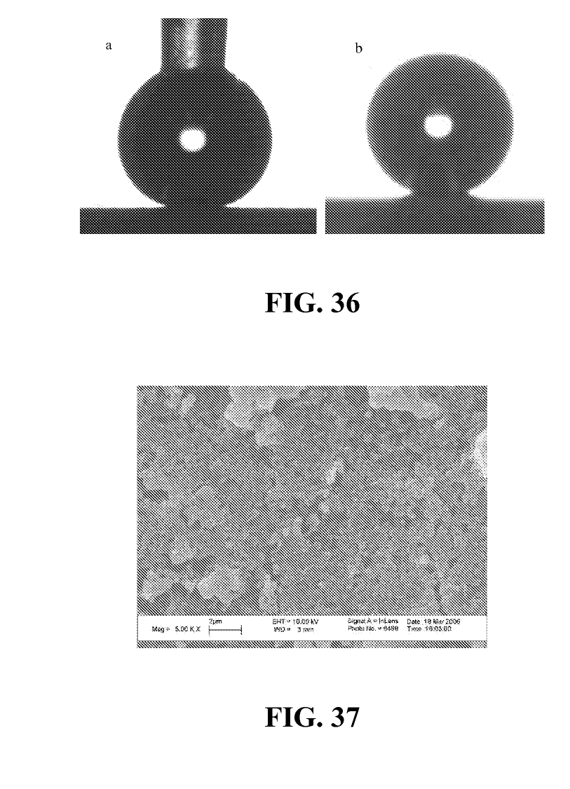

(i) At the beginning of the TiO₂ particle synthesis, add silica sphere/ethanol dispersion (˜5% wt, 10 ml) (150 nm), which was synthesized using the Stöber method—the TiO₂/SiO₂ (core) particles can be formed as shown in FIG. 34A; and

(ii) After the synthesis reaction of TiO₂ particles started for 30 minutes, silica sphere/ethanol dispersion (˜5% wt, 10-50 ml) was added to the reaction media for another four and one-half (4.5) hours. The particles SiO₂ (shell)/TiO₂ (core) can be formed as shown in FIG. 34B.

### Method Example IX

(i) Mix TEOS 4 ml, ammonia hydroxide (25% V/V) 4 ml, and absolute ethanol 50 ml and deionized water 3 ml at 60° C. and keep stirring for five (5) hours. In another reaction vessel, mix absolute ethanol 100 ml, sodium chloride (0.1 mol/L) 0.4 ml, and add into the solution 2 ml TPT within 10 min. Then add the prepared (TEOS-based) silica particle colloid to the TPT based solution, keep stirring at room temperature for 48 hours. The resultant mixture will provide a multi species TiO₂/SiO₂ particle solution for further application.

(ii) Mix TEOS 4 ml, ammonia hydroxide (25% V/V) 4 ml, and absolute ethanol 50 ml and deionized water 3 ml at 60° C. and keep stirring for five (5) hours. In another reaction vessel, mix absolute ethanol 100 ml, sodium chloride (0.1 mol/L) 0.4 ml, and add into the solution 2 ml TPT within 10 min, and then keep stirring for four (4) hours, TiO₂ particle size is around 800 nm. Then, add the as prepared silica particle colloid, and keep stirring at room temperature for 48 hours. The SiO₂/TiO₂ particles were formed.

(iii) Dipcoat a glass slide with the as prepared colloidal. After solvent was dried, the contact angle was measured, and water droplets spread out on the surface, thus indicating a low contact angle and hydrophilic property. Then, the as coated surface was post-treated with PFOS. After this treatment, a contact angle of 169.5° and hysteresis of 2.0° was achieved, which showed a superhydrophobic surface.

When an elastomeric (silicone) surface was substituted for the glass slide described in step (iii) above, the same coating method was used. However, after the solvent was dried from the surface, the contact angle was immediately measured, and the water droplets spread on the surface. After four (4) hours at ambient conditions, the autophobic process caused the contact angle to increase to 168.2.6° and provided a hysteresis of 2.5°, which showed a superhydrophobic surface.

Similar results occurred with an EPDM (with oil) surface that gave an autophobic contact angle of 166.8° and hysteresis of 2.6°, which showed a superhydrophobic surface. An EPDM (without oil) surface gave a completely hydrophylic surface that did not show any autophobic benefit. Subsequent treatment with a silane would be expected to develop superhydrophobicity.

### Method Example X

(i) Mix TEOS 6 ml, ammonia hydroxide (25% V/V) 15 ml, and absolute ethanol 200 ml at 60° C. and keep stirring for five (5) hours. A silica colloid resulted with a diameter of 80 nm. The APS/ethanol (0.3 ml/5 ml) solution was added to the original solution and then stirred for 12 hours at 60° C. under N₂ atmosphere. The silica surface functionalized with amino groups was prepared.

(ii) In a second reaction vessel, mix absolute ethanol 100 ml, sodium chloride (0.1 mol/L) 0.4 ml, and add into the solution 2 ml TPT within 30 min, and then add glycidoxy propyl trimethoxysilane (GPS)/ethanol solution (0.25 g/5 g) into the mixture and stir for 24 hours. The TiO2 surface was then functionalized with epoxy groups. Then add the TiO2/ethanol mixture to the prepared silica/ethanol mixtures. A functionalized SiO2/TiO2 structure with different particle sizes was formed.

(iii) The as prepared mixtures can be directly coated on silicone surface by dipcoating (single or multiple dips), and after 3-4 hours, the surface changed from superhydrophilicity to superhydrophobicity. As the number of dipping processes is increased, it resulted in higher contact angles and lower hysteresis, which means improved superhydrophobicity. This phenomenon shows the autophobicity of the as surface. Multi-factor ageing (QUV) test showed that superhydrophobicity was maintained out to 1000 hour and 2000 hour aging periods. After ageing the surfaces showed self recovery as evidenced by changes in contact angle and hysteresis. Under quick evaporation of ethanol after dipcoating, even monodispersed silica coating can show initial superhydrophobicity with a contact angle of over 160° and a hysteresis of below 5°.

Spincoating, spray coating and painting on surfaces also are good choices for coating surfaces.

The surfaces were characterized with SEM, and TABLE 11 shows examples of different combination of different particles, wherein for silica particle preparation, the data is related to method example VI, and for titania particles, the data is related to method example X(ii)).

TABLE 11

| | Example a | Example b | Example c | Example d |
|---|---|---|---|---|
| Mean Particle Size - | 0.6 | — | 0.2 | 0.8 |
| largest fraction | | | | |
| (μm) | | | | |
| Mean Particle Size - | 175 | — | 50 | 15 |
| smallest fraction | | | | |
| (nm) | | | | |
| Ratio Mean | 3.4 | | 4 | 53.3 |
| Largest/Mean Smallest | | | | |
| Ratio of Standard | 0.4-8 | 0.1-3 | 0.2-10 | 0.05-5 |
| Deviation | | | | |
| Largest/Standard | | | | |
| Deviation Smallest | | | | |
| Species of Largest | Titania | Silica | Ceria | Calcium |
| | | | | Carbonate |
| Species of Smallest | Silica | Titania | Silica | Titania |
| Single application, | 168° | 170° | — | — |
| Untreated Contact Angle | | | | |
| (degrees) | | | | |

When using these multi-modal particles to coat the surface of silicone parts from a number of manufacturers, the surfaces achieved superhydrophobicity without any further surface treatment (this could be termed surface autophobicity). After the silica particles were dipcoated or painted on the silicone surface, after a certain period, the surface will change from hydrophilicity to hydrophobicity and finally to superhydrophobicity as shown in FIG. 35. It is most probable that the diffusion of the silicone oils (oligomers or cyclics) accounts for this effect. The particles used were SiO₂/TiO₂ with TiO₂ around 800 nm and SiO₂ of 150 nm as shown in FIG. 35.

The autophobicity (improvement in hydrophobicity with resting time) of silicone surfaces (the effect applies to all silicone surfaces) is shown in FIG. 35. The coating process commences at −0.5 hour and is complete at 0 hour—note contact angle of silicone is 120° before treatment, and it falls with coating, and then radically improves with the autophobicity.

When the superhydrophobic silicone surface was further treated with PFOS, the contact angle increases to 176° and hysteresis<1° as shown in FIG. 37.

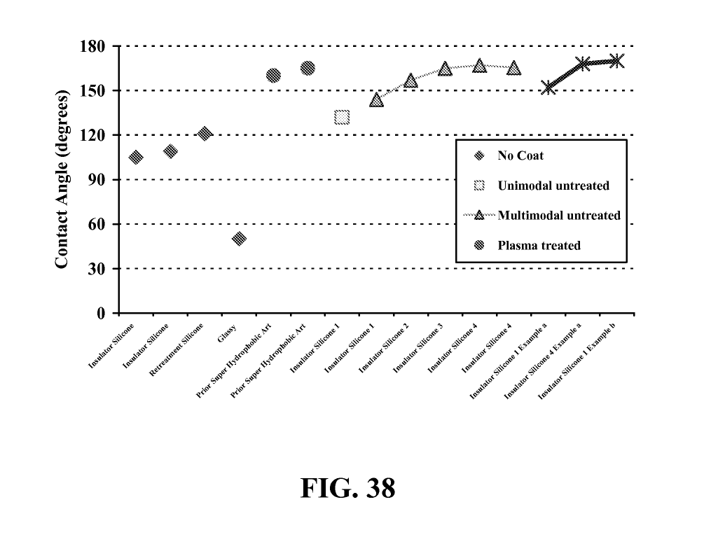

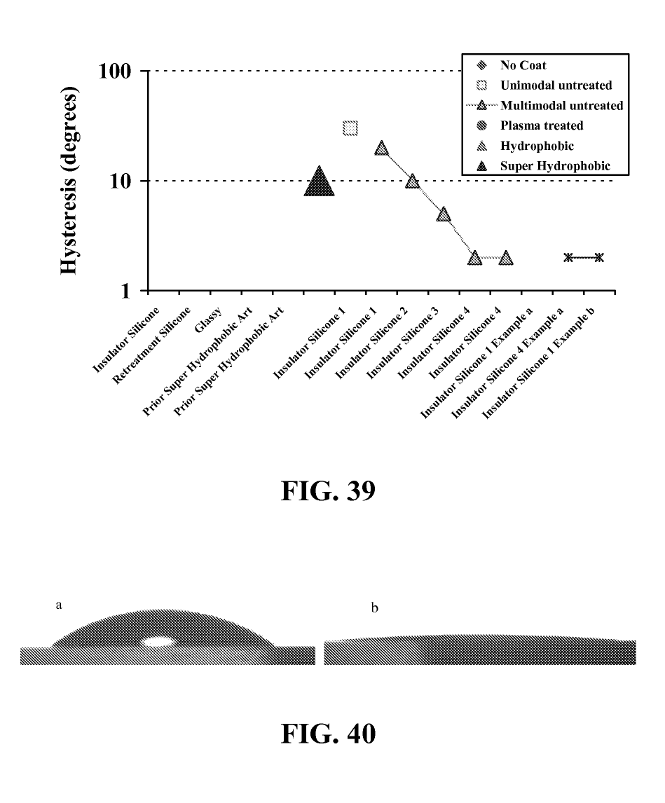

FIG. 38 illustrates the relative position of the measured contact angle of different surfaces. The three marks connected by a line show the multi-species surfaces. The five triangles connected by a line show the multi-modal surfaces. FIG. 39 shows the relative position of the measured hysteresis of different surfaces. The two marks connected by a line show the multi-species surfaces. The five triangles connected by a line show the multi-modal surfaces. The single large triangle represents the superhydrophobic limit.

Pre-Treatments

The surfaces that are to be coated need to be sufficiently hydrophilic so that the liquids are retained on the surface. That is, if the surface is not hydrophilic enough, then uniform liquid films can not be formed. This effect is particularly important for glassy surfaces, like porcelains. The pre-treatment process makes the to-be-coated surface more receptive to surface coatings such as silica sol.

Through the pre-treatment, the surface will have more reactive sites, and after the coatings are applied, better chemical bonding is formed, and thus the adhesion between the substrate and the coatings is greatly enhanced by the chemical bonding.

In an example of the pre-treatment, microscope slides were cleaned in Piranha solution (70:30 (vol/vol) mixture of 96% sulfuric acid and 30% aqueous hydrogen peroxide), and subsequently rinsed extensively with de-ionized water and ethanol. The water droplet contact angle measurement changed from around 40° to below 15° due to the formation of hydroxyl groups on the slide surface (FIG. 40).

This procedure can also be replaced with UV or ozone cleaning for five minutes followed by water and ethanol rinsing or oxygen plasma cleaning for two (2) minutes.

Post-Treatments

Early work showed that it is not sufficient to have only a rough surface to achieve superhydrophobicity; it is equally important to have the correct surface chemistry. This is shown by the hydrophobicity of the template surfaces that are enhanced by surface treatment. The surface modification is termed “post-treatment”. Post-treatment means surface modification by low surface energy materials through the formation of chemical bonding between the substrate and the surface modification agents. In experiments, fluorocarbon trichloro silanes was used.

This step is not necessary for silicone surfaces, but does improve the superhydrophobicity of the surfaces. On ceramic surfaces (those that do not have the mobile species that activate the surface in silicones), post-treatment is clearly beneficial, if not required.

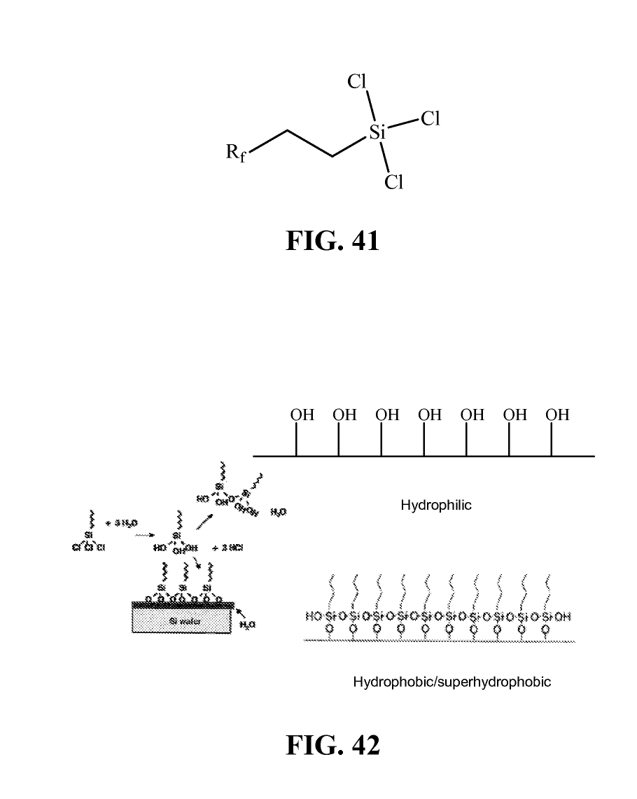

Post-treatment to maintain long term multi-factor QUV stability of the superhydrophobicity is especially effective when using fluorosilanes (FIG. 41). FIG. 42 is a schematic of the process of silane monolayer formation.

### Method Example XI

Silica samples were placed in a PFOS/n-hexane solution (10 mM) for 30 minutes to permit adsorption of a PFOS layer on the SiO₂ surface. Subsequently, the samples were rinsed and treated at 150° C. in air for 30 minutes to promote silane hydrolysis, and 220° C. for five (5) minutes to promote the condensation between silane molecules, thereby forming a stable silanated layer on the silica surface.

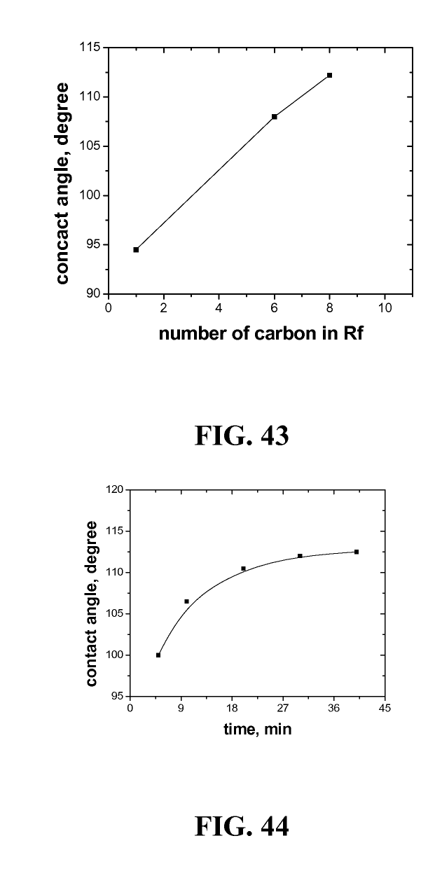

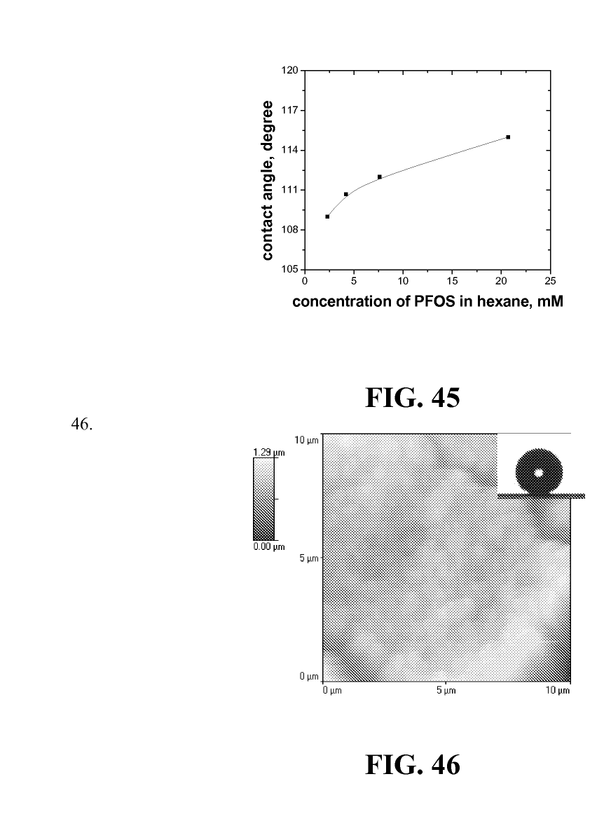

The practical aspects of post-treatment can be critical, as the effects are due to:
Chemical structure of the silanes—FIG. 43 and TABLE 12
Treatment Time—FIG. 44
Concentration—FIG. 45

TABLE 12 illustrates the R_{f} chain length (FIG. 41) effect on contact angle and hysteresis.

TABLE 12

| Glass treatment | Contact Angle | Hysteresis |
|---|---|---|
| {carbon chain length} | (degrees) | (degrees) |
| None | 50 | — |
| Trifluoropropyl {C3} | 117 | — |
| Fluorooctyl (PFOS) {C8} | 164 | 5-8 |
| Fluorodecyl (HFDS) {C10} | 172 | 2 |

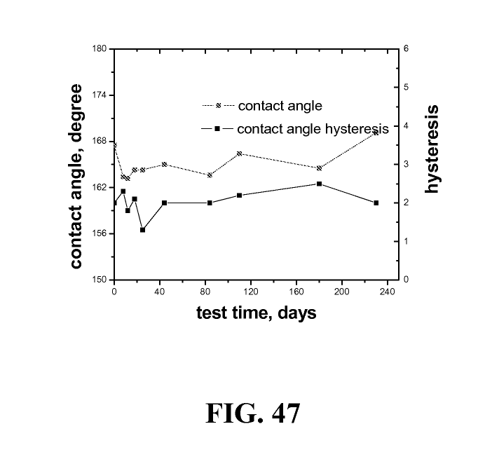

FIG. 46 shows a porous silica surface structure using an AFM. The UV stability of the fluorosilane treated silica surface on a glass substrate is good (FIG. 47). The accumulated test time was 230 days, and the surface was still stable in both the contact angle and the hysteresis measurement.

To demonstrate the practical applicability of the various embodiments described herein, sheets of insulation used to manufacture external insulators were coated. The deposited surfaces were created using the sol-gel process for multi-modal, multi-species.

The surface received post-treatment to elevate the superhydrophobicity. These surfaces were subjected to multi factor ageing using temperature, UV and water. The surfaces completed the ageing period (1000 hours) with a practically useful level of retained superhydrophobicity.

Recovery, Hysteresis, and Other Findings

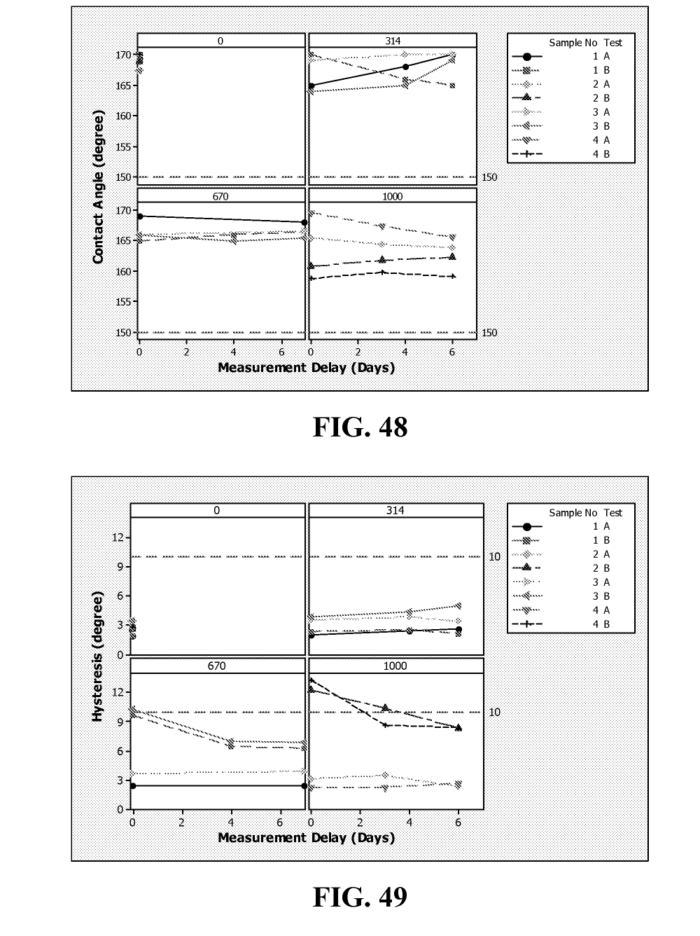

Work related to the present invention has uncovered many novel, non-obvious and surprising results conventionally unknown in the superhydrophobic art, as clearly evident in TABLES 13-17, and FIGS. 48 and 49. For example, it was found
that UV and condensation are major contributors to the ageing of the surfaces (low P values in the ANOVA of TABLES 13-16);
that temperature on its own seems to have only a minor overall effect (see test A data);
that the measurement delay shows that there is a significant recovery of hydrophobicity after the end of ageing; this being particularly true of the Hysteresis data (P=0.193 in TABLES 14 and 16);
that the hysteresis is a very sensitive indicator of superhydrophobicity; and
that in these experiments, the contact angle and hysteresis are least sensitive to different types of silicones, thereby strongly suggesting that these effects are common phenomena to all silicones (high P values in the ANOVA of TABLES 13-17), and indicating that the observed effects might be expected with elastomeric or flexible substrates.

Table 13 is a Reduced Analysis of Variance (ANOVA) Table for Contact Angle (degrees):

TABLE 13

| Source | DF | P |
|---|---|---|
| Measurement Delay (Days) | 1 | 0.782 |
| Material | 1 | 0.805 |
| Test | 1 | 0.000 |
| Ageing Time (H) | 3 | 0.000 |
| Error | 35 | |
| Total | 41 | |

Table 14 is a Reduced Analysis of Variance (ANOVA) Table for Hysteresis (degrees):

TABLE 14

| Source | DF | P |
|---|---|---|
| Measurement Delay (Days) | 1 | 0.509 |
| Material | 1 | 0.974 |
| Test | 1 | 0.000 |
| Ageing Time (H) | 3 | 0.000 |
| Error | 35 | |
| Total | 41 | |

Multi-factor Condensation, Thermal and UV ageing on these samples continues out past 1,000 hours.

Further findings are shown below and FIGS. 48 and 49, where the data are contact angle measurements on plaques of different elastomeric materials (two replicate samples from two different silicone bases [1 and 3] and [2 and 4]) were subjected to different times (hours—detailed in the different panes) under multi factor ageing protocols. Silicone bases 1, 2 are silicone plaques from Cooper Power, and 3, 4 are from Tyco.

### A—Single Factor—Temperature Cycles

B—Multi factor—Condensation and Temperature and UV Cycles
Note lower level of base ageing between A vs B
Note recovery (decrease in hysteresis, increase in contact angle) in the days after removal of plaques from the ageing chamber
The statistical significance is shown in the standard Analysis of Variance Tables (ANOVA)

Table 15 is an Analysis of Variance for Contact Angle (degrees), using Adjusted SS for Tests:

TABLE 15

| | | | | | | |
|---|---|---|---|---|---|---|
| Source | DF | Seq SS | Adj SS | Adj MS | F | P |

| | | | | | | |
|---|---|---|---|---|---|---|
| Measurement Delay | 1 | 16.504 | 6.631 | 6.631 | 1.51 | 0.224 |
| (Days) | | | | | | |
| Material | 1 | 18.903 | 2.247 | 2.247 | 0.51 | 0.477 |
| Test | 1 | 38.242 | 36.476 | 36.476 | 8.28 | 0.005 |
| Ageing Time (H) | 5 | 182.094 | 182.094 | 36.419 | 8.27 | 0.000 |
| Error | 73 | 321.506 | 321.506 | 4.404 | | |
| Total | 81 | 577.249 | | | | |

Table 16 is an Analysis of Variance for Hysteresis (degrees), using Adjusted SS for Tests:

TABLE 16

| Source | DF | Seq SS | Adj SS | Adj MS | F | P |
|---|---|---|---|---|---|---|
| Measurement Delay | 1 | 12.42 | 87.63 | 87.63 | 11.81 | 0.001 |
| (Days) | | | | | | |
| Material | 1 | 15.35 | 0.01 | 0.01 | 0.00 | 0.979 |
| Test | 1 | 429.1 | 431.64 | 431.64 | 58.18 | 0.000 |
| Ageing Time (H) | 5 | 462.35 | 462.35 | 92.47 | 12.47 | 0.000 |
| Error | 73 | 541.54 | 541.54 | 7.42 | | |
| Total | 81 | 1460.8 | | | | |

Tables 15 and 16 illustrates the P statistic is the critical aspect—the lower the value the more significant the effect. Table 17 collates the information contained in the P statistic of Tables 15 and 16 and displays it as the significance of the individual factors.

TABLE 17

| | | Significance (%) | | Rank |
|---|---|---|---|---|
| | | Contact | | Significance |
| Source | Description | Angle | Hysteresis | of Factor |
| Measurement | Recovery time | 77.6 | 99.9 | 3 |
| Delay (Days) | after removal | | | |
| | from the multi | | | |
| | factor ageing | | | |
| | chamber | | | |
| Material | Different version | 52.3 | 2.1 | 4 |
| | of the | | | |
| | elastomeric | | | |
| | (Silicone) | | | |
| | materials | | | |
| Test | Different multi | 99.5 | >99.9 | 2 |
| | factor ageing test | | | |
| | (A & B) | | | |
| Ageing Time (H) | Cumulative time | >99.9 | >99.9 | 1 |
| | in the multi | | | |
| | factor ageing | | | |
| | chamber | | | |

As shown, the analysis shows that one needs to look at both contact angle and hysteresis, and why it is believed that the technique will work on a range of surfaces, and that recovery will be a feature of elastomers, but most probably not on ceramics/glass insulators.

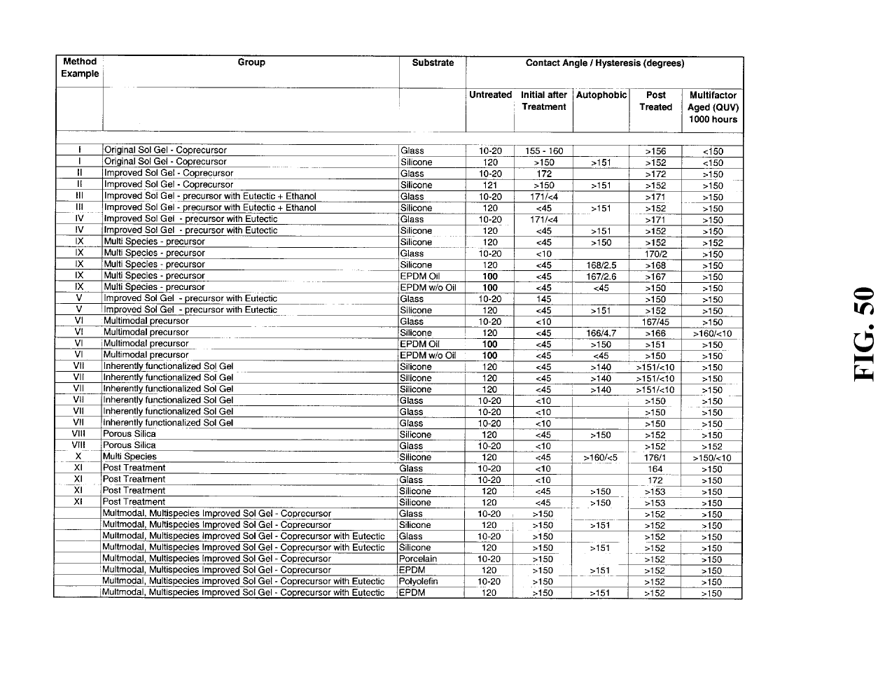

FIG. 50 is a chart including various data from the technology disclosed and described in the above Material Examples I-V and Method Examples I-XI, showing in chart form the practical manufacture and assessment of improved hydrophobic (often superhydrophobic) coatings for a variety of substrates. FIG. 50 displays a current understanding of the performances of these surfaces in both the aged and unaged states. A key performance element is the improved hydrophobicity between the untreated and multi-factor aged states. The beneficial aspects of precursors/coprecursors, autophobicity, post-treatment and multi-modalities/species are all evidenced with their additive and interacting (first and higher orders) in FIG. 50.

While the invention has been disclosed in its preferred forms, it will be apparent to those skilled in the art that many modifications, additions, and deletions can be made therein without departing from the spirit and scope of the invention and its equivalents as set forth in the following claims.

1. An inorganic, stable superhydrophobic surface, wherein stable is defined as the surface maintaining a contact angle of greater than 150 degrees after 1,000 hours of multi factor ageing tests.

2. The superhydrophobic surface of claim 1, the surface being upon a dielectric substrate.

3. The superhydrophobic surface of claim 1, the surface being upon a semiconductor substrate.

4. The superhydrophobic surface of claim 1, the surface being upon an insulator substrate.

5. The superhydrophobic surface of claim 1, the surface being upon a conductor substrate.

6. The superhydrophobic surface of claim 1, the surface being UV-stable, wherein UV-stable is defined as the surface maintaining a contact angle of at least 150 degrees after 1,000 hours of a UV weathering test according to ASTM D 4329.

7. The superhydrophobic surface of claim 1, the surface maintaining a contact angle of greater than 150 degrees after 5,500 hours of multi factor ageing tests.

8. The superhydrophobic surface of claim 1, the surface maintaining a contact angle of greater than 162 degrees after 1,000 hours of multi factor ageing tests.

9. The superhydrophobic surface of claim 1, the surface maintaining a contact angle of greater than 162 degrees after 5,500 hours of multi factor ageing tests.

10. The superhydrophobic surface of claim 1, the surface being at least one coating upon a substrate, the coating comprising particles having multi-modal size distributions.

11. The superhydrophobic surface of claim 10, wherein the at least one coating comprises at least two primary-sized particles, a first particle size greater than a second particle size, and wherein the ratio of the mean particle size of the first particle size to the mean particle size of the second particle size is greater than approximately 2.4.

12. The superhydrophobic surface of claim 11, wherein the ratio of the mean particle size of the first particle size to the mean particle size of the second particle size is greater than approximately 8.

13. The superhydrophobic surface of claim 11, wherein the ratio of the mean particle size of the first particle size to the mean particle size of the second particle size is greater than approximately 40.

14. The superhydrophobic surface of claim 1, the surface being at least one coating upon a substrate, the coating comprising single species particles.

15. The superhydrophobic surface of claim 1, the surface being at least one coating upon a substrate, the coating comprising multi-species particles.

16. The superhydrophobic surface of claim 15, wherein the particles have uni-modal size distribution.

17. The superhydrophobic surface of claim 15, wherein the particles have multi-modal size distribution.

18. The superhydrophobic surface of claim 15, wherein the at least one coating comprises at least two primary-sized particles, a first particle size greater than a second particle size, and wherein the ratio of the mean particle size of the first particle size to the mean particle size of the second particle size is greater than approximately 2.4.

19. The superhydrophobic surface of claim 18, wherein the ratio of the mean particle size of the first particle size to the mean particle size of the second particle size is greater than approximately 8.

20. The superhydrophobic surface of claim 18, wherein the ratio of the mean particle size of the first particle size to the mean particle size of the second particle size is greater than approximately 40.

21. A method of forming an inorganic, stable superhydrophobic surface comprising the following steps:
mixing one or more precursors and a solvent to form a first solution;
reacting over time a mixed solution to form a reacted solution;
applying the reacted solution to a clean substrate; and
gelling the reacted solution on the substrate to form the inorganic, stable superhydrophobic surface,
wherein the mixed solution is the first solution.

22. The method according to claim 21, further comprising the step of mixing an acid and water in the first solution to form a second solution, wherein the mixed solution is the second solution.

23. The method according to claim 21, further comprising the step of mixing a eutectic with the first solution to form a second solution, wherein the mixed solution is the second solution.

24. The method according to claim 21, wherein one or more precursors is functionalized.

25. The method according to claim 21, wherein stable is defined as the surface maintaining a contact angle of greater than 150 degrees after 1,000 hours of multi factor ageing tests.

26. The method according to claim 21, wherein the substrate is a dielectric substrate.

27. The method according to claim 21, wherein the substrate is an insulating substrate.

28. The method according to claim 21, wherein the surface is UV-stable, wherein UV-stable is defined as the surface maintaining a contact angle of at least 150 degrees after 1,000 hours of a UV weathering test according to ASTM D 4329.

29. The method according to claim 21, the surface maintaining a contact angle of greater than 150 degrees after 5,500 hours of multi factor ageing tests.

30. The method according to claim 21, the surface maintaining a contact angle of greater than 162 degrees after 1,000 hours of multi factor ageing tests.

31. The method according to claim 21, the surface maintaining a contact angle of greater than 162 degrees after 5,500 hours of multi factor ageing tests.

32. The method according to claim 21, wherein the one or more precursors are organometallic.

33. The method according to claim 32, wherein the one or more precursors are tetra organometallic and tri organometallic.

34. The method according to claim 21, wherein the solvent is an alcohol.

35. The method according to claim 34, wherein the solvent is ethanol.

36. The method according to claim 21, wherein the step of mixing the one or more precursors and the solvent to form the first solution is run at a temperature of between 10-80° C.

37. The method according to claim 22, wherein the acid is one of hydrochloric acid, sulfuric acid, phosphoric acid, chromic acid, oxalic acid, formic acid, and acetic acid.

38. The method according to claim 22, wherein the step of mixing the acid and water in the first solution to form the second solution is run at a temperature of between 10-40° C.

39. The method according to claim 21, wherein the step of reacting over time the mixed solution to form the reacted solution runs between 30 minutes and 8 hours.

40. The method according to claim 21, wherein the step of applying the reacted solution to the clean substrate is by dipcoating.

41. The method according to claim 21, wherein the step of applying the reacted solution to the clean substrate is by spincoating.

42. The method according to claim 21, wherein the step of applying the reacted solution to the clean substrate is by spray coating.

43. The method according to claim 21, wherein the step of applying the reacted solution to the clean substrate is by painting.

44. The method according to claim 21, comprising the further step of cleaning the substrate prior to the step of applying the reacted solution to a clean substrate, wherein the step of cleaning the substrate includes Piranha solution cleaning.

45. The method according to claim 21, comprising the further step of cleaning the substrate prior to the step of applying the reacted solution to a clean substrate, wherein the step of cleaning the substrate includes alkali/H₂O₂ cleaning.

46. The method according to claim 21, comprising the further step of cleaning the substrate prior to the step of applying the reacted solution to a clean substrate, wherein the step of cleaning the substrate includes UV/ozone cleaning.

47. The method according to claim 21, comprising the further step of cleaning the substrate prior to the step of applying the reacted solution to a clean substrate, wherein the step of cleaning the substrate includes mechanical abrasion of the substrate.

48. The method according to claim 21, wherein the step of gelling the reacted solution on the substrate to form the inorganic, stable superhydrophobic surface is by a base catalyzed reaction.

49. The method according to claim 21, further comprising the step of fine-tuning the strength of the resultant inorganic, stable superhydrophobic surface by adjusting the ratio of the precursors if more than one precursor is used.

50. The method according to claim 21, further comprising the step of firing to strengthen the surface structure.

51. The method according to claim 21, further comprising the step of post-treatment of the structured surface for improved hydrophobicity.

52. A process of improving the superhydrophobic properties of a surface of a substrate comprising a near-ambient temperature surface treatment using a coupling agent to increase the contact angle and decrease the hysteresis of the surface.

53. The near-ambient temperature surface treatment process according to claim 52, further comprising using at least one eutectic liquid as a solvent and templating agents for the creation of surface structures.

54. The near-ambient temperature surface treatment process according to claim 52, wherein the surface is an inorganic, stable superhydrophobic surface, wherein stable is defined as the surface maintaining a contact angle of greater than 150 degrees after 1,000 hours of multi factor ageing tests.

55. A method of forming an inorganic, stable superhydrophobic surface comprising the following steps:
mixing a sol with nanoparticles to form a first solution;
applying the first solution to a clean substrate; and
gelling the first solution on the substrate to form the inorganic, stable superhydrophobic surface;
wherein the nanoparticles are used as sacrificial templating agents

56. The method of forming an inorganic, stable superhydrophobic surface according to claim 55, wherein stable is defined as the surface maintaining a contact angle of greater than 150 degrees after 1,000 hours of multi factor ageing tests.
